(19) United States
(12) Patent Application Publication
(10) Pub. No.: US 2002/0158899 A1
(43) Pub. Date: Oct. 31, 2002

(54) Portal system and method for managing resources in a networked computing environment

(76) Inventor: Robert Raymond, Ft Collins, CO (US)

Correspondence Address: HEWLETT-PACKARD COMPANY, Intellectual Property Administration, P.O. Box 272400, Fort Collins, CO, 80527-2400, US

(21) Appl. No.: 09/845,427

(22) Filed: Apr. 30, 2001

(51) Int. Cl. G06F 13/00

(52) U.S. Cl. 345/736

(57) ABSTRACT

A service information portal (SIP) and associated methodology for providing customer-based management information of networked computing environments for Internet service providers (ISPs), outsourcers, and enterprise service providers (“service providers”). The invention enables such service providers to provide the network administrators/users/customers/network managers/network operators (“network administrators”) they serve with flexible, extensible, tailored, in-depth views of hosted computing environments in an intuitive graphical format. Generally, the invention extracts from relevant computing environment entities specified information for managing the outsourced computing environment. The specified information is presented on a customized display for consideration and interaction by the network administrator. Specifically, aspects of the invention include a database of executable portal view profiles each designed for and/or by a particular network administrator. Each such portal view profile references one or more portal data miner modules included in a library of such modules. When a portal view profile is invoked, the referenced data miner modules are executed to access hardware and/or software entities in the computing environment for information that is displayed to assist a network administrator manage the outsourced computing environment.

### RELATED APPLICATIONS

The following commonly owned applications may be related to this application and are incorporated by reference herein below and elsewhere in this application:

U.S. patent application entitled “DYNAMIC GENERATION OF CONTEXT-SENSITIVE DATA AND INSTRUCTIONS FOR TROUBLESHOOTING PROBLEM EVENTS IN INFORMATION NEWORK SYSTEMS”, filed on Apr. 30, 2001 under Attorney Docket No. 10992465-1.

U.S. patent application entitled “SYSTEM AND METHOD FOR MANAGING DATA MINER MODULES IN AN INFORMATION NETWORK SYSTEM”, filed on Apr. 30, 2001 under Attorney Docket No. 10015949-1.

U.S. patent application entitled “SYSTEM FOR DYNAMIC CUSTOMER FILTERING OF MANAGEMENT INFORMATION PRESENTED THROUGH A WEB-BASED PORTAL”, filed on Apr. 30, 2001 under Attorney Docket No. 10006612-1.

U.S. patent application entitled “SYSTEM FOR DISPLAYING TOPOLOGY MAP INFORMATION THROUGH THE WEB”, filed on Apr. 30, 2001 under Attorney Docket No. 10006654-1.

U.S. patent application entitled “METHOD AND APPARATUS FOR CUSTOMIZABLY CALCULATING AND DISPLAYING HEALTH OF A COMPUTER NETWORK”, filed on Jan. 17, 2001 under Attorney Docket No. 10006622-1.

U.S. patent application entitled “SYSTEM FOR SECURE ACCESS TO INFORMATION PROVIDED BY A WEB APPLICATION”, filed on Apr. 30, 2001 under Attorney Docket No. 10006664-1.

### BACKGROUND OF THE INVENTION

1. Field of the Invention

The present invention is directed to computer network systems and, more particularly, to management of a networked computing environment.

2. Related Art

Computer networks are widely used to provide increased computing power to facilitate the sharing of resources and to enable communication to occur between disperse users. Today's computer networks are large complex systems with many components from a large variety of vendors interconnected to form a networked computing environment. Networks may include a number of computer devices within a room, a building or a site that are interconnected by a high speed local data link such as local area network (LAN), token ring, Ethernet or the like. Local networks in different locations may be interconnected by techniques such as packet switching, microwave links and satellite links to form a world-wide network such as the Internet.

Network management systems have been utilized in the past to assist a network administrator/network operator/network manager/customer/user/(“network administrator” herein) manage a network system. Network management is the common term given to the task of planning, maintaining, securing and operating a network system. There are many different entities that need to be managed in a network. These entities include, for example, routers, bridges, PC's, workstations, minicomputers, supercomputers, printers, file servers, switches, communications systems, databases, software applications and the like. Such hardware and software entities are referred to herein simply as “entities” or “objects” for ease of reference. As the types of entities that form or reside on a network system increase, so to does the scope of information that must be gathered and processed by the network administrator to properly manage the network. The task of managing entities in a computing environment, therefore, requires greater expertise and becomes more difficult as the network system becomes larger and more complex.

The importance of a properly managed network system has increased dramatically in recent years as “e-business” continues to become an increasingly vital part of how companies due business. Because of the increased criticality and complexity of computing environments, today's companies turn to service providers—internal to the company or an external organization—to provide reliable, available and high-performance information network systems. In addition to managing the computing environment, service providers face an increasing challenge to attract, satisfy and retain customers. In turn, the network administrators for these customers are demanding more from their service providers, including greater visibility into the services that they are outsourcing.

Typically, there is a management system for different types of entities on the network system. For example, large networks often include network managers, database managers and software application managers, to name a few. Due to the diversity of such managed entities, such management systems are commonly referred to as “domain managers”. Conventional domain managers collect large volumes of information that must be evaluated by the network administrator to effectively manage the network system. Conventional network management systems, therefore, place a tremendous burden on the network administrator. The network administrator must know or determine which information is relevant to the management function being performed, and must also know or determine the source or sources of such information. The network administrator is often required to understand the manner in which the information is to be retrieved from such source or sources, and to run multiple tools or programs to obtain the desired information. In addition, the network administrator must be well versed in a wide variety of types of entities such as network systems, software applications, and the like in order to properly manage the various entities on the network system. As a result, providing network administrators visibility into their outsourced computing environments has become increasing difficult while simultaneously becoming increasingly important to the customer.

### SUMMARY OF THE INVENTION

The present invention is directed to a service information portal (SIP) and associated methodology for providing customer-based management information of networked computing environments for Internet service providers (ISPs), outsourcers, and enterprise service providers (“service providers”). The invention enables such service providers to provide the network administrators/users/customers/network managers/network operators (“network administrators”) they serve with flexible, extensible, tailored, in-depth views of hosted computing environments in an intuitive graphical format. Generally, the invention extracts from relevant computing environment entities specified information for managing the outsourced computing environment. The specified information is presented on a customized display for consideration and interaction by the network administrator. Specifically, aspects of the invention include a database of executable portal view profiles each designed for and/or by a particular network administrator. Each such portal view profile references one or more portal data miner modules included in a library of such modules. When a portal view profile is invoked, the referenced data miner modules are executed to access hardware and/or software entities in the computing environment for information that is displayed to assist a network administrator manage the outsourced computing environment.

Advantageously, by enabling the modification of the portal view profile, including which and how data miner modules are referenced, the invention provides the network administrator with a portal view display having a format, depth and breadth designed by the network administrator. As such, the invention provides the network administrator with any desired visibility into the outsourced computing environment. This facilitates the efficient management of the computing environment. For example, related management information may be graphically arranged in close proximity to enable the network administrator to see in a single portal view all information relevant to a particular task. This enables the network administrator to correlate, compare and contrast and otherwise perform analytical functions without having to perform any other task to obtain or view the desired information. The elimination of such distractions and the proximate display of related information in a single view facilitates quick assessment of the managed resources.

Another advantage of the present invention is that the portal view profiles are extensible. As new entities are added to the computing environment a corresponding data miner module can be added to obtain information therefrom. The invention, therefore, allows not only for the improved management of today's networked systems of existing entities, it also allows for new entities, technologies, applications and protocols.

In addition, providing the network administrator with management information from various entities across the computing environment eliminates the need for the network administrator to know or determine which information is relevant to the particular management task. This also relieves the network administrator from knowing or determining the source or sources of such information and the manner in which the information is to be retrieved from such source entity or entities. This is a significant benefit because not all network administrators are knowledgeable about each of the different types of network entities and management systems. Providing the network administrator only with information helpful to a particular management function while eliminating from display other, less relevant information, prevents the network administrator from spending time obtaining and reviewing information that is unnecessary for the task at hand. This also reduces the likelihood that the network administrator will perform management tasks improperly due to the inclusion of such irrelevant information in the management process.

A number of aspects of the invention are summarized below, along with different embodiments of each of the summarized aspects. It should be understood that the embodiments are not necessarily inclusive or exclusive of each other and may be combined in any manner that is non-conflicting and otherwise possible, whether they be presented in association with a same or different aspect of the invention. It should also be understood that these summarized aspects of the invention are exemplary only and are considered to be non-limiting.

In one aspect of the invention, a service information portal (SIP) is disclosed. The SIP displays a customer-based portal view display of networked computing environments. The portal view display includes management information of a type, depth and breadth specified by an end-user in a format and arrangement also specified by the end-user. In one embodiment, the service information portal includes a portal view profile manager and a portal view display manager. The portal view profile manager that provides a portal view profile associated with the end user, wherein the portal view profile is configured and causing generation of a customized portal view display. The portal view display manager that executes the portal view profile to generate the customized portal view display. In certain embodiments, the service information portal also includes a portal view edit manager that enables the end user to interact with the referenced data miners to modify portions of the portal view profile that reference the data miners. Alternatively, the service information portal can also include a help display manager that displays help files in response to an end user's request.

In another aspect of the invention, a service information portal for providing a network administrator with a customizable, extensible portal view display of management information reflective of a desired aspect of a computing environment is disclosed.

In a further aspect of the invention, a method for displaying a portal view display of management information relevant to a particular end user and computing environment. The method includes the steps of A) receiving an identifier of the end user; B) generating management information specified by the end user, the management information directed only to a portion of the computing environment for which the end user is authorized to manage; and C) displaying the management information on a display device in a format, arrangement specified by the end user.

Various embodiments of the present invention provide certain advantages and overcome certain drawbacks of the conventional techniques. Not all embodiments of the invention share the same advantages and those that do may not share them under all circumstances. Further features and advantages of the present invention as well as the structure and operation of various embodiments of the present invention arc described in detail below with reference to the accompanying drawings. In the drawings, like reference numerals indicate identical or functionally similar elements. Additionally, the left-most one or two digits of a reference numeral identifies the drawing in which the reference numeral first appears.

### BRIEF DESCRIPTION OF THE DRAWINGS

The present invention is pointed out with particularity in the appended claims. The above and further advantages of this invention may be better understood by referring to the following description taken in conjunction with the accompanying drawings, in which:

FIG. 1 is a block diagram of an exemplary computer environment suitable for implementing the service information portal of the present invention.

FIG. 2 is a schematic block diagram of the primary components of a service information portal in accordance with one embodiment of the present invention.

FIG. 3A is a functional block diagram of a module management system introduced in FIG. 2 in accordance with one embodiment of the present invention.

FIG. 3B is a flowchart of the processes performed in one embodiment of the module management system of the present invention.

FIG. 4 is an illustration of a module registration file specification in .dtd (document type descriptor) format in accordance with one embodiment of the present invention.

FIG. 5 is an illustration of a network health module registration file in .dtd format and compliant with the specification illustrated in FIG. 4 in accordance with one embodiment of the present invention.

FIG. 6 is a functional block diagram of one embodiment of the portal view management system introduced in FIG. 2.

FIG. 7 is a functional block diagram of the portal view profile manager illustrated in FIG. 6 in accordance with one embodiment of the present invention.

FIG. 8 is an illustration of the structure and format of a portal view profile in accordance with one embodiment of the present invention.

FIG. 9 is an illustration of a network health portal view profile specification in .dtd (document type descriptor) format in accordance with one embodiment of the present invention.

FIG. 10 is an illustration of the relationship between FIGS. 10A through 10G.

FIGS. 10A-10G together illustrate an example of a portal view profile in accordance with one embodiment of the present invention.

FIG. 11 is a functional block diagram of the portal view display manager illustrated in FIG. 6 in accordance with one embodiment of the present invention.

FIG. 12 is an illustration of the relationship between FIGS. 12A-12C.

FIGS. 12A-12C together illustrate a portal view display corresponding to the portal view profile illustrated in FIGS. 10A-10G in accordance with one embodiment of the present invention.

FIG. 13 is a detailed portal view display in accordance with one embodiment of the present invention.

FIG. 14 is a functional block diagram of the portal view edit manager illustrated in FIG. 6 in accordance with one embodiment of the present invention.

FIG. 15 is an illustration of a network health edit view display in accordance with one embodiment of the present invention.

FIG. 16 is a functional block diagram of the help display manager illustrated in FIG. 6 in accordance with one embodiment of the present invention.

FIG. 17 is a flow chart of the processes performed by the service information portal in accordance with one embodiment of the present invention.

FIG. 18 is a more detailed flow chart of the processes performed by service information portal in accordance with one embodiment of the present invention.

FIG. 19 is a flowchart of the processes performed in accordance with one embodiment of service information portal of the present invention to edit a portal view display.

### DETAILED DESCRIPTION

I. Introduction

The present invention is directed to a service information portal (SIP) and associated methodology for providing customer-based management information of networked computing environments for Internet service providers (ISPs), outsourcers, and enterprise service providers (“service providers”). The invention enables such service providers to provide the network administrators/users/customers/network managers/network operators (“network administrators”) they serve with flexible, extensible, tailored, in-depth views of hosted computing environments in an intuitive graphical format. Generally, the invention extracts from relevant computing environment entities specified information for managing the outsourced computing environment. The specified information is presented on a customized display for consideration and interaction by the network administrator. Specifically, aspects of the invention include a database of executable portal view profiles each designed for and/or by a particular network administrator. Each such portal view profile references one or more portal data miner modules included in a library of such modules. When a portal view profile is invoked, the referenced data miner modules are executed to access hardware and/or software entities in the computing environment for information that is displayed to assist a network administrator manage the outsourced computing environment.

Advantageously, by enabling the modification of the portal view profile, including which and how data miner modules are referenced, the invention provides the network administrator with a portal view display having a format, depth and breadth designed by the network administrator. As such, the invention provides the network administrator with any desired visibility into the outsourced computing environment. This facilitates the efficient management of the computing environment. For example, related management information may be graphically arranged in close proximity to enable the network administrator to see in a single portal view all information relevant to a particular task. This enables the network administrator to correlate, compare and contrast and otherwise perform analytical functions without having to perform any other task to obtain or view the desired information. The elimination of such distractions and the proximate display of related information in a single view facilitates quick assessment of the managed resources.

Another advantage of the present invention is that the portal view profiles are extensible. As new entities are added to the computing environment a corresponding data miner module can be added to obtain information therefrom. The invention, therefore, allows not only for the improved management of today's networked systems of existing entities, it also allows for new entities, technologies, applications and protocols.

In addition, providing the network administrator with management information from various entities across the computing environment eliminates the need for the network administrator to know or determine which information is relevant to the particular management task. This also relieves the network administrator from knowing or determining the source or sources of such information and the manner in which the information is to be retrieved from such source entity or entities. This is a significant benefit because not all network administrators are knowledgeable about each of the different types of network entities and management systems. Providing the network administrator only with information helpful to a particular management function while eliminating from display other, less relevant information, prevents the network administrator from spending time obtaining and reviewing information that is unnecessary for the task at hand. This also reduces the likelihood that the network administrator will perform management tasks improperly due to the inclusion of such irrelevant information in the management process.

For simplicity and illustrative purposes, the principles of the present invention are described with reference to an exemplary network application of a service information portal (SIP). However, one of ordinary skill in the art would readily recognize from the present disclosure that the present invention can be implemented in any network node in any computing environment, and is applicable to all types of network management systems.

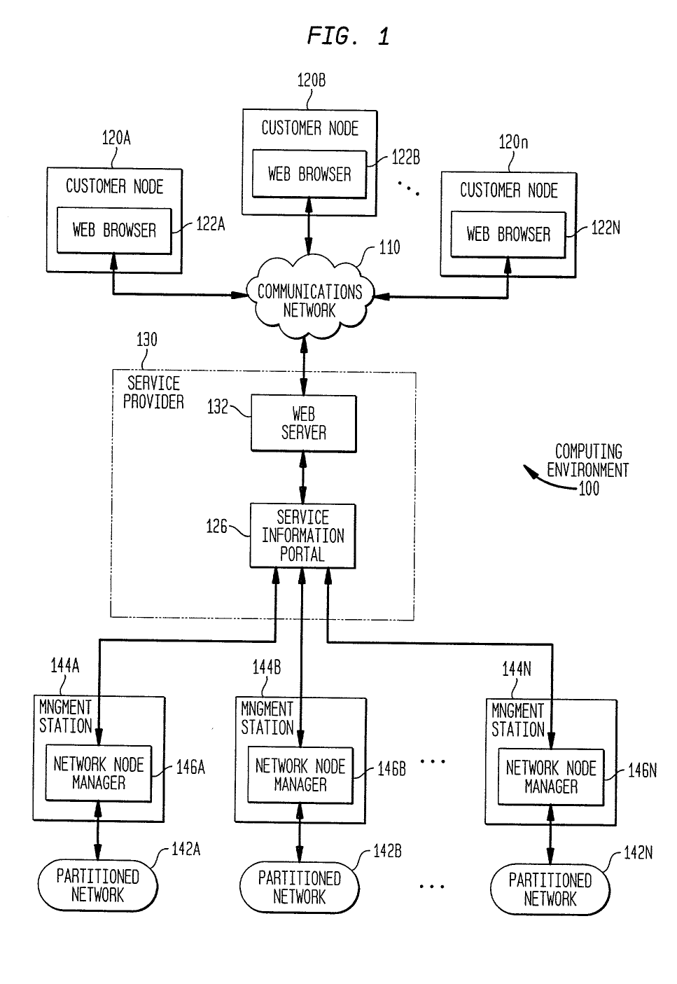

As used herein, the term “computing environment” refers to virtually any local or distributed system, processing platform, network, system and application. FIG. 1 is a block diagram of an exemplary networked computing environment 100 in which the service information portal of the present invention can be implemented. Computing environment 100 includes individual computing platforms generally referred to as network nodes on which software programs are executed and data is stored. Network nodes include but are not limited to workstations, personal computers, thin clients, file servers, computer servers and host computers. In general, network elements are anything that participates in the service of providing for the transfer of data and resources in computing environment 100. Networked computing environment 100 includes a communications network infrastructure 110 formed of numerous network devices to which is connected customer nodes 120 and a service information portal (SIP) 126 provided by a service provider 130. Network devices include, for example, LANs, routers, bridges, gateways, multiplexers, switches, connectors and the like. These network devices are considered to be well-known in the art and are not described further herein.

Networked computing environment 100 may be implemented as a local area network, wide area network, wireless network, the Internet or the like. In this exemplary embodiment, networked computing environment 100 utilizes a hypertext transfer protocol (HTTP) to provide communication services between web browsers 122 residing on customer nodes 120 and a web server 132 provided by service provider 130 to access service information portal 126. Web browsers 122 can be, for example, the NAVIGATOR from the Netscape Communications Corporation of Mountain View, Calif., USA, or the INTERNET EXPLORER from the Microsoft Corporation of Redmond, Wash., USA, among others. It should be understood that any one of a variety of other network protocols such as TCP/IP, X.25, and others can also be used to provide such communication services.

Service information portal 126 is managed by service provider 130 to provide a variety of network services to customers 120 including the portal view display system and methodology of the present invention. The network services may include Internet services, electronic mail (e-mail) services, data storage, network management services and the like. A customer 120 may not prefer to create and/or manage a network system. Oftentimes, such decisions are driven by a lack of expertise, cost, etc. In order to receive network services, a customer 120 may utilize a service provider 130. Service provider 130 configures a portion of network 100 into partitioned networks 142 and allocates each partitioned network to a particular customer 120. In one aspect of the invention, service information portal 126 provides secure, customized management services to customers 120 as described in commonly-owned U.S. patent application entitled “SYSTEM FOR DYNAMIC CUSTOMER FILTERING OF MANAGEMENT INFORMATION PRESENTED THROUGH A WEB-BASED PORTAL”, filed on Apr. 30, 2001 under Attorney Docket No. 10006612-1, and U.S. patent application entitled “SYSTEM FOR SECURE ACCESS TO INFORMATION PROVIDED BY A WEB APPLICATION”, filed on Apr. 30, 2001 under Attorney Docket No. 10006664-1, both of which are hereby incorporated by reference herein in their entirety.

Service information portal 126 communicates with entities in network partitions 142 through a management station (MS) 144. Management stations 144 may be configured to include a network node manager 146 to provide a management node function for each of the partitioned networks 142. Existing network management protocols include Simple Network Management Protocol (SNMP), Internet Control Message Protocol (ICMP) and many proprietary network management protocols. Service information portal 126 communicates with management stations 144 using one of these or another protocol.

Service information portal 126 is a software tool that displays management information specified for or by the network administrator in a desired format to facilitate computing system management. Service information portal 126 extracts from relevant network system entities pertinent management information. These entities include, for example, routers, bridges, PC's, workstations, minicomputers, supercomputers, printers, file servers, switches, communications systems, databases, software applications and any other information technology system. Such hardware and software entities are referred to herein simply as “entities” or “objects” for ease of reference. The information is presented on a user interface 128 for consideration and interaction by the network administrator. The user interface 128 can include a video display screen keyboard, mouse, printer, etc., and provides all types of interactions with a network administrator. The user interface 128 controls the screen, keyboard, mouse and pointer and provides the user with a view of network system 100 that is being managed. User interface 128 receives information from the Service information portal 126 in accordance with the present invention as described below.

II. Service Information Portal 126

A. Introduction

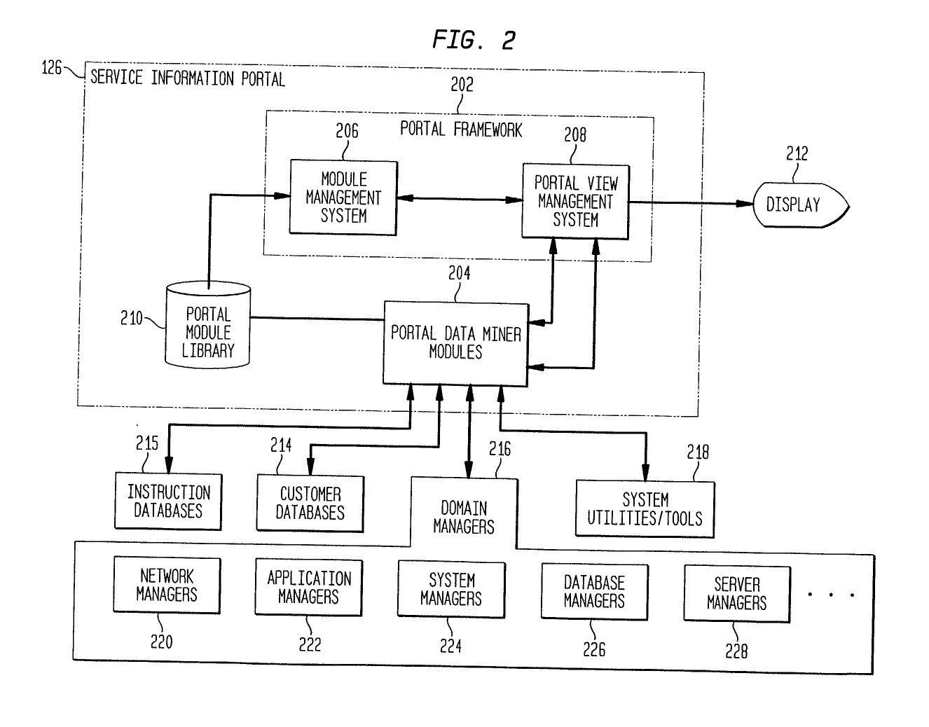

FIG. 2 is a schematic block diagram of the primary components of a service information portal 126 in accordance with one embodiment of the present invention. Service information portal 126 includes a portal framework 202 configured in accordance with the present invention to provide a network administrator with a customized portal view of management information pertinent to an outsourced computing environment associated with that network administrator. Portal framework 202 utilizes portal data miner modules (“data miners”) 204 to extract desired information from the computing environment and to provide a specified level of detail of the extracted information to the network administrator in a customized portal view. A library 210 of such data miner modules 204 is managed by a module management system 206 of portal framework 202. The display of the management information generated by specified data miners 204 is controlled by a portal view management system 208 of portal framework 202.

Portal data miner modules 204 are typically executable software programs that, when executed, access, call, query, or otherwise interface with external entities. Portal data miner modules 204 obtain, generate or cause the generation of specific management information reflective of the state of the computing environment 100. The term “data miner” as used herein refers to all types of software modules that gather or cause the generation of data related to the management of a computing environment. For example, portal data miner modules 204 include software modules that mine data from one or more domain managers 216. In addition, portal data miner modules 204 can include software programs that access knowledge databases provided by a customer of computing environment 100. In addition, portal data miner modules 204 include software programs that call or invoke system utilities and tools that, when executed, generate additional management information. Thus, the term “portal data miner modules 204”, as used herein, refers to virtually any mechanism that results on the generation of management information, whether directly, such as through the accessing of a database, or indirectly, such as through the generation of a command that causes another software program to generate management information.

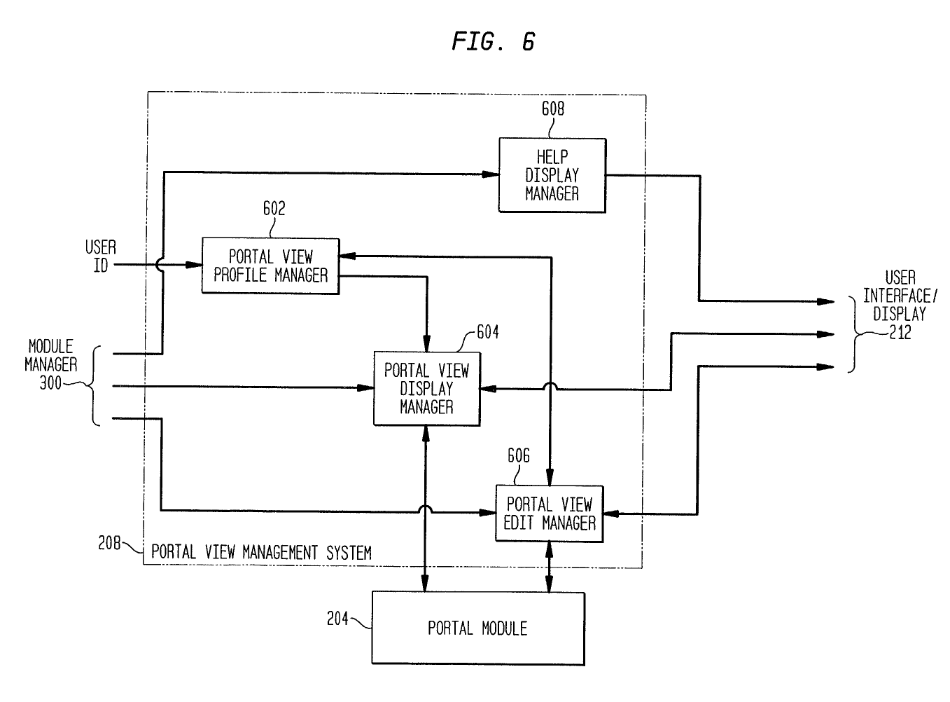

In FIG. 6 data miners 204 share an interface with four exemplary external sources. A primary source of management information is domain managers 216. Domain managers 216 maintain significant amounts of information pertaining to the health, status, configuration, etc., of the entities they manage. This includes historical as well as contemporaneous information. Many domain managers 216 offer report generation functions which can be invoked by a data miner 204 to obtain, for example, the noted historical information. The type and scope of the information provided by domain managers 216 can generally be specified by a requesting data miner 204. Such management systems are accessed for management information in accordance with aspects of the present invention. The maimer in which a domain manager 216 is to be queried, the information made available, and other features of communicating with a domain manager 214 is a function of the individual domain manager 216 and is implemented in those portal data miner modules 204 configured to access such domain managers 216. Accordingly, such communication protocols and data formats are not described herein.

Exemplary domain managers 216 will now be described with reference to FIG. 2. Network managers 220 are software products that manage individual networks as well as large collections of networks. An exemplary network manager 220 is the OpenView® Network Node Manager available from Hewlett-Packard Company, Palo Alto, Calif., USA. (OPENVIEW is a registered trademark of Hewlett-Packard Company.)

Application managers 222 are software products that manage the software applications executing on a particular node or server of network 100. Examples of commercially available application managers 222 are the Patrol® available from BMC Software, Inc., Houston, Tex., USA. and the OpenView® SPI, available from Hewlett-Packard Company, Palo Alto, Calif., USA. (PATROL is a registered trademark of BMC software, Inc.)

System managers 224 can be any management tool that manages the infrastructure of the particular network or components of network system 100. Examples of system managers 224 include the OpenView® VantagePoint™ available from Hewlett-Packard Company, Palo Alto, Calif., USA. (VantagePoint is a trademark of Hewlett-Packard Company.)

Database managers 226 are software products that manage large, complex databases that are accessible to many users across network system 100. Examples include any of the Portal® database manager products available from BMC Software, Inc. Server managers 228 are software products that assist a network administrator manage the operations of each server in a network. Examples include any of the Portal® server manager products available from BMC Software, Inc., and the OpenView® VantagePoint Operations™ available from Hewlett-Packard Company.

As noted, these management systems are generally and collectively referred to herein as domain managers 216. The term “domain” reflects the variety of hardware and software that is being managed by each of the managers 220-228. That is, for each aspect or “domain” of networked computing environment 100, there are one or more management systems configured to manage that particular aspect or domain of components, systems, devices, software, etc. It should be understood that this list of domain managers 216 is exemplary only, and that service information portal 126 of the present invention can operate with other domain managers 216 now or later developed.

Domain managers 216 typically include software and systems that monitor the operations of the managed objects. Domain managers 216 gather and store information pertaining to the managed entities such as status information, health information, availability, configuration, historical activities, and a wide range of other information. Such information that is made available or provided to service information portal 126 is referred to herein as “management information” since it is provided to a network administrator in accordance with the present invention for any purpose desired by the network administrator. Thus, the term “management information” is to be interpreted broadly to include any information generated by data miners 204 in response to commands or requests generated by service information portal 126.

Computing environment 100 can include systems or devices that are unique to a particular customer. Customer databases 608 are external sources of information provided by the customer or the customer's systems that contain information that is desirable to access to obtain management information. For example, in one embodiment, customer databases 608 includes a data repository of management information generated by proprietary tools not shown in the figures. Instruction databases 208 are repositories of instructional management information. Instruction databases 215 include, for example, specific or detailed instructions regarding how to interpret management information generated by a particular network entity.

As noted, one of the significant benefits of aspects of the present invention is to provide the network administrator with management information that assists the network administrator through a management task. Such management information can be as detailed as desired and can be presented to the network administrator in virtually any form. For example, text, graphical elements, examples, etc., may be presented. Different levels of information, selectable by the network administrator, can be provided. HTTP links can be used to allow novice users drill down to more specific instructions that may not otherwise be useful to a more experienced network administrator. Links to video clips, manuals and the like can also be provided. In addition, data miners 204 can invoke system utilities and tools 218. Such utilities and tools 218 include programs that generate diagnostic or status information, and can reside in any number of devices in computing environment 100. There are numerous data miner modules 204 that can be utilized or created to generate management information with the present invention. A number of examples are set forth below.

As noted, portal framework 202 manages and executes portal data miner modules 204 to obtain management information for display to the network administrator in a portal view display. Portal framework 202 includes a module management system 206 and a portal view management system 208. Module management system 206 manages a database of portal data miner modules 204. Module management system 206 defines the elements necessary to invoke an implementation of a portal data miner module 204. Multiple instances of each portal data miner module 204 can be executed simultaneously, with each such instance representing a different implementation of the data miner module 204. Each such implementation is defined by module management system 206, and can have a different name, generate different management information from a different domain manager 216, and present the retrieved management information in a different presentation format. This provides for the capability of implementing a data miner module 204 differently for the same or different network administrator for the same or different purpose.

Portal view management system 208 invokes one or more portal data miner modules 204 in accordance with specifications provided by the network administrator. Portal view management system 208 enables service providers to provide the network administrators they serve with flexible, extensible, tailored, in-depth views of hosted computing environments in an intuitive graphical format. Generally, portal view management system 208 invokes specified portal data miner modules 204 to extract from relevant computing environment entities specified information for managing the outsourced computing environment. Portal view management system 208 presents the specified information on a customized display for consideration and interaction by the network administrator. Portal view management system 208 provides the network administrator with a portal view display having a format, depth and scope designed by the network administrator. As such, portal view management system 208 provides the network administrator with any desired visibility into the outsourced computing environment.

B. Detailed Description

Each of the introduced elements of service information portal 126 will now be described in detail. As described above and illustrated in FIG. 2, service information portal 126 primarily includes portal framework 202 comprising module management system 206 that manages a library 210 of portal modules 204, and portal view management system 208 that executes certain portal modules 204 to obtain management information from computing environment 100. Module management system 206 will be described next below followed by a description of portal view management system 208.

1. Module Management System 206

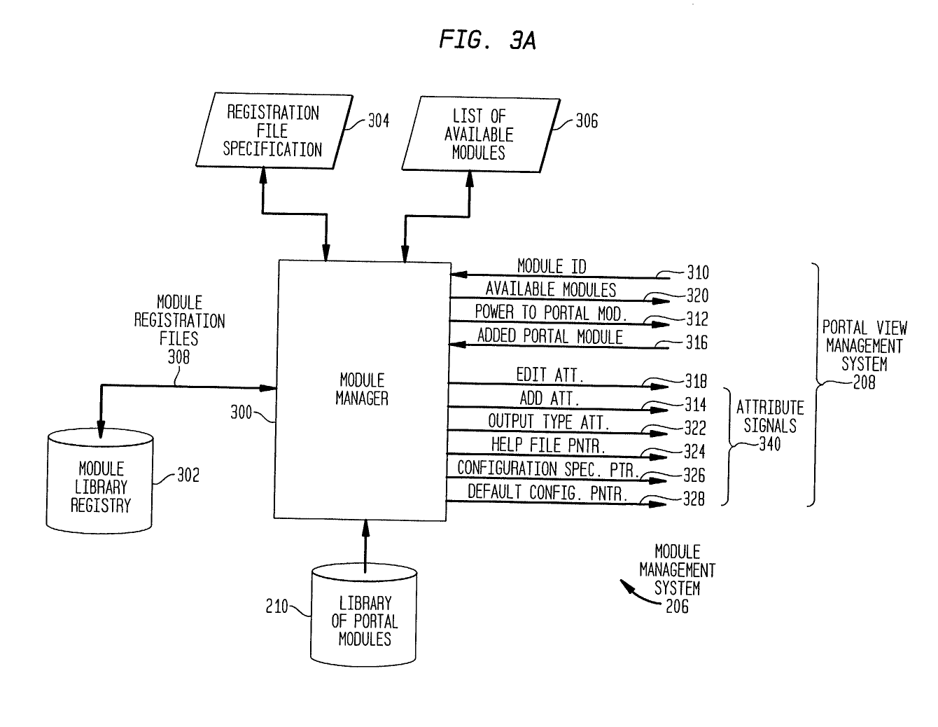

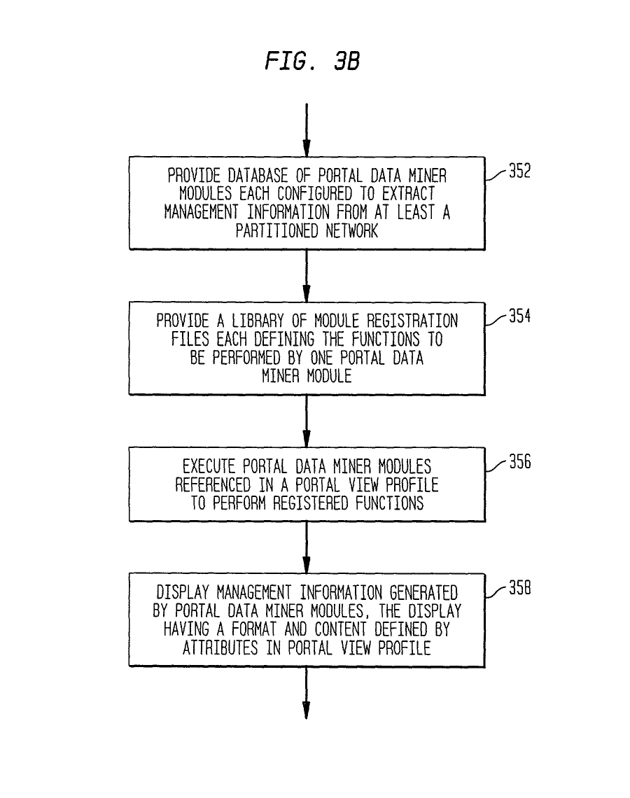

FIG. 3A is a functional block diagram of module management system 206 in accordance with one embodiment of the present invention. Generally, module management system 206 includes a library 302 of registration files 308 for data miner modules 204 stored in portal data miner library 210. A module manager 300 manages data miner library 210 and provides access to those data miner modules 204 that have registration files 308 that specify the requisite components for a data miner module implementation.

Specifically, module library registry 302 is a database of registration files 308 each defining an implementation of a data miner module 204 that is to be made available for future reference by portal view management system 208. Each module registration file 308 corresponds to a portal data miner module 204. As noted, there may be more than one registration file 208 that corresponds and defines a different implementation of data miner module 204.

A module specification file 304 specifies the requisite components that must be identified to define an implementation of a data miner module implementation. These components may be attributes, for which the attribute values are provided in registration file 308, or files, for which the path is identified in registration file 308. Upon system start-up, module manager 300 retrieves each registration file 308 from registry 302 and verifies that it complies with the specification file 308.

Module manager 300 then retrieves from library 210 those data miners 204 having registration files 308 that comply with a module specification file 304. Module manager 300 stores the retrieved data miners 204 in local memory as described below. Thus, data miner modules 204 that are registered can be executed by service information portal 126. Additional information such as the specified attribute values of a registered data miner implementation and the locations of supporting files or programs, is maintained by module manager 300 for distribution to requesting portal view management system 208.

As noted, to insure that a proper data miner implementation is defined, module manager 300 maintains a registration file specification 304. The format of module registration files 308 are verified by module manager 300 by comparing registration files 308 with specification file 304. As noted, this is typically performed when a registration file is initially read by module manager 300. In alternative embodiments, this verification is performed when a new module registration file 308 is initially added to registration file library 302.

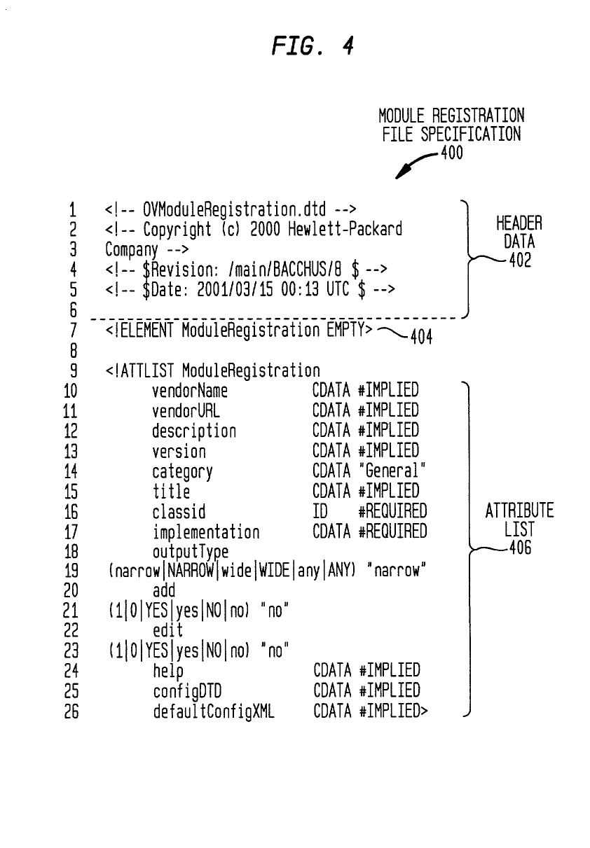

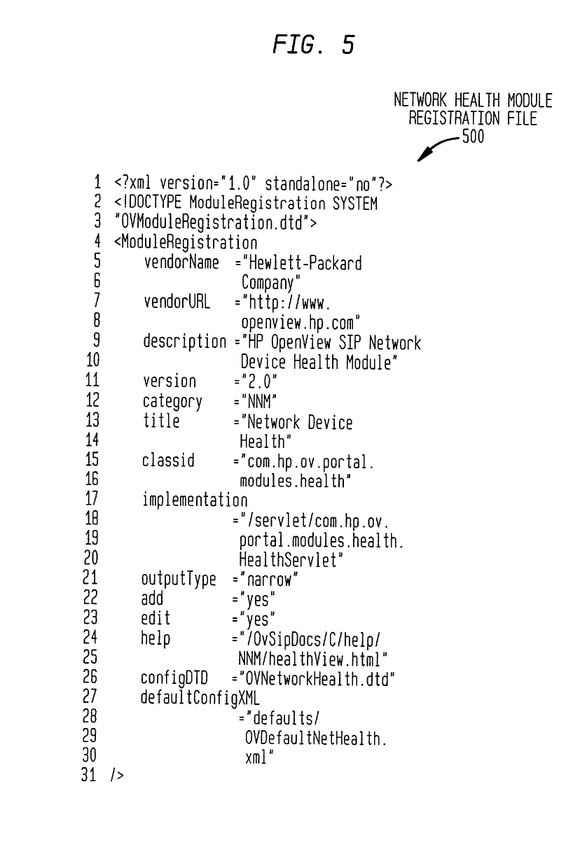

FIG. 4 is an exemplary module registration file specification 400 in document type descriptor (.dtd) file format. FIG. 5 is an exemplary module registration file 500 for a portal data miner module 204 that generates network health management information. Lines 1-6 of module registration specification 400 together define a header 402 that includes general file information such as the file name, copyright information, revision date and the like. Explanatory comments providing additional information could also be included. Each module registration is identified with a module registration element 404 having syntax shown in line 7 of specification file 400. Each module registration includes an attribute list as shown on lines 9-26 of specification file 400. Attribute list 406 defines the implementation of the corresponding portal data miner module 204.

Referring to FIG. 5, line 1 of registration file 500 provides general file information not pertinent to the invention. On lines 2 and 3, the specification file against which this module registration file 500 is to be verified is identified (“‘OVModuleRegistration.dtd’”). In this example, this is module registration specification file 400, as shown on line 1 thereof (“OVModuleRegistration.dtd”). Thus, module manager 300 verifies module registration file 500 with specification file 400.

In this example, there are a number of attributes each set forth in specification file 400. The first attribute is the name of the vendor supplying the referenced portal module 204 (“vendorName”), as shown on line 10. The acceptable syntax is character data (“CDATA”) and this attribute need not be included in the registration file (“IMPLIED”). Referring to FIG. 5, at lines 5 and 6 of registration file 500 the vendor name of the identified network health data miner is set forth as “Hewlett-Packard Company.”

The URL to the vendor's web site (“vendorURL”) is specified at line 11 of file 400. In FIG. 5, this attribute is shown at lines 7 and 8 (“http://www.openview.hp. com”). The next two attributes set forth on lines 12 and 13 of specification file 400 are description (“description”) and version (“version”) of the referenced portal module 204. In the example shown in FIG. 5, these attributes are set forth in lines 7-10. There, the corresponding portal module 204 is identified as the “HP OpenView SIP Network Device Health Module,” version “2.0.”

The next attribute set forth on line 14 of specification file 400 is a category designation for the referenced portal data miner module 204. The character data default entry is the “General” category. Referring to FIG. 5, the specified category is “NNM” representing network node manager. This indicates that the referenced portal module 204 is one that accesses a network node manager for the management information. Specification file 400 also sets forth the title (“title”) and an object class identifier (“classid”) attributes. The title is a character string that is not required. When it is required it is displayed in a title region of the corresponding portal view window. This is described in further detail below with reference to an exemplary portal view display. The class ID attribute is of a format referred to as “ID” and is required. Referring to FIG. 5, the title attributes is “Network Device Health” and the class id attribute specifies the object class “com.hp.ov.portal. modules.health”.

Attribute list 406 includes an attribute that references the implemented portal module 204 (“implementation”). This is a required attribute as specified in specification file 400. Referring to the network health registration file 500 in FIG. 5, the referenced network health portal module 204 is “servlet/com.hp.ov.portal.modules.health. HealthServlet,” which is a pointer to the Java applet portal data miner module 204.

The next attribute is set forth on lines 18 and 19 of specification file 400, and indicates that the type of output format that can be specified for presenting the information generated by the referenced network health portal module 204. The type of output can be either narrow for a summarized view or wide for a expanded view. The options are shown in FIG. 4, with the “narrow” option being the default value. Referring to line 21 of module registration file 500, the narrow output format is specified.

As will be described in detail below, in accordance with aspects of the invention, the network administrator may change the membership of registered portal data miner modules 204. On lines 20-21 of specification file 400 an attribute indicating whether the referenced data miner module 204 can be added is set forth. If this attribute has an affirmative value (the options are shown in FIG. 5), the title set forth on line 15 will be included in a displayed list of data miner modules 204 from which the network administrator can select data miner modules to add to those currently registered. This is discussed in detail below. The default value for this attribute is “no” as shown on line 21 of specification file 400. In the example, registration file 500 includes this attribute with a value of “yes” indicating that the referenced network health data miner module 204 can be added to a currently existing registry 302 of available portal data miner modules 204.

Similarly, lines 22 and 23 of specification file 400 define an attribute indicating whether the referenced portal data miner module 204 supports a module editing function (described below). The yes/no options are set forth on line 23 of specification file 400. On line 23 of registration file 500, this attribute is set to a value of “yes.” This will cause portal view management system 208 to include in the corresponding module view window an icon indicating the availability of the edit capability.

At line 24 of specification file 400 a help attribute in which the path of the corresponding help file is provided. This attribute need not be specified. The help file path provided on lines 24 and 25 of network health registration file 500 is “/OVSipDocs/C/help/NNM/healthView.html”. Thus, portal view management system 208 displays an icon with the portal view window (described below) for the referenced data miner module 204 indicating that a help function is supported. A network administrator's graphical selection of the help icon will invoke the referenced HTML help file, as described below.

As will be described in detail below, the referenced data miner module 204 is invoked with parameters set forth in a portal view configuration file. The grammar for the relevant parameters as may be used in the portal view profile is included in another .dtd file specified by the “configDTD” attribute. Referring to registration file 500, this .dtd file is specified at line 26 as “OVNetworkHealth.dtd”. The content of this .dtd file is described in detail below.

When a portal module 204 is initially registered, a default configuration file that concurs with the configuration specification file 304 specified in the attribute is provided to portal view management system 208. This default configuration file is an XML file as the attribute name implies. In the network health registration file 500, this attribute value is set forth on lines 28-30 as “defaults/OVDefaultNetHealth. xml”.

Referring again to FIG. 3A, module manager 300 retrieves each of the registration files 308 stored in registry 302 upon initiation. Module manager 300 validates each of the registration files 308 against specification file 304. When a registration file 308 is deemed valid, the corresponding portal module 204 referenced in the validated registry file 308 is transferred from library 210 to a local memory accessible to portal view management system 208.

Also, module manager 300 generates a list 306 of available data miner modules 204 indicating which data miners 204 have been successfully stored in local memory and are thereafter available for execution by portal view management system 208. This list is provided to portal view management system 208 as available modules 320. As will be described in detail below, this list is displayed when the network administrator indicates that a different set of portal data miner modules 204 are to be executed to generate a desired portal view display.

As shown in FIG. 3A, module manager 300 receives a module ID 310 from portal view management system 208 and, if the registration file 308 was determined to be valid, returns a pointer 312 to the referenced portal data miner module 204 in local memory. This pointer 312 is the path specified in the “implementation” attribute of registration file 308 for that portal data miner module 204.

Module manager 300 is shown in FIG. 3A to generate a series of attribute signals 340 that are received by portal view management system 208. These attributes are retrieved from module registration file 308 and correspond to the attributes defined in attribute list 406 described above. For example, the path to a help file (“help” attribute), configuration specification file (“configDTD” attribute) and default configuration file (“defaultConfigXML”) are provided to portal view management system 208 as shown by the generation of help file pointer 324, configuration specification pointer 326 and default configuration pointer 328, respectively. Other attributes used by portal view management system 208 are provided as values output by module manager 300. These include add attribute 314 (“add” attribute), edit attribute 318 (“edit” attribute) and output type attribute 322 (“outputType” attribute).

As noted, the network administrator may add a portal data miner module 204 to library 210. To do so, a registration file 302 that satisfies specification file 304 must also be generated. This addition of a portal data miner module 204 is represented by an added portal module signal 316 generated by portal view management system 208 and provided to module manager 300.

Advantageously, the arrangement shown in FIG. 3A provides many benefits not provided heretofore. For example, each portal data miner module 204 can be referenced by more than one module registration file 308. Each such registration file 308 can provide a different name, presentation format, etc., and utilize different information generated by the referenced data miner module. This provides for the capability of implementing multiple instances of the same data miner module 204 by the same or different users for the same or different purposes.

FIG. 3B is a flowchart of the processes performed in one embodiment of the module management system 206 of the present invention. At block 352 a database of portal data miner modules is provided. Each portal data miner module 204 is configured to extract or otherwise cause the generation of management information related to managed entities in computing environment 100.

At block 354, a library 210 of module registration files 308 is provided. Each registration file 308, as noted, defines the functions to be performed by the registered portal data miner module 204; that is, the registration file 308 determines how the portal data miner module 204 will be implemented.

The portal data miner module 204 is executed at block 356. The portal data miner modules 204 is implemented in accordance with the corresponding registration file 308. At block 358 the management information generated by the execute portal data miner module 204 is displayed. The depth and breadth as well as the format of the displayed management information is defined by attributes provided separately from the module registration file 308.

Thus, there can be multiple registration files each implementing a common portal view module differently. Furthermore, the ultimate display format and content can be varies by the setting of attributes. As noted below, such attributes may be set in a portal view profile for a particular user or group of users. Thus, one network administrator can request high level information while another network administrator can request the same information with detailed source information. Alternatively, a network administrator can have multiple references to a same portal data miner module 204, each resulting in the generation of management information pertaining to a different aspect of a different managed network partition 142.

Additional descriptions of the structure and function of various embodiments of module management system 206 may be found in commonly owned U.S. patent application entitled “DYNAMIC GENERATION OF CONTEXT-SENSITIVE DATA AND INSTRUCTIONS FOR TROUBLESHOOTING PROBLEM EVENTS IN INFORMATION NEWORK SYSTEMS”, filed on Apr. 30, 2001 under Attorney Docket No. 10992465-1, and U.S. patent application entitled “SYSTEM AND METHOD FOR MANAGING DATA MINER MODULES IN AN INFORMATION NETWORK SYSTEM”, filed on Apr. 30, 2001 under Attorney Docket No. 10015949-1, the specifications of which are hereby incorporated by reference herein in their entirety.

2. Portal View Management System 208

FIG. 6 is a functional block diagram of one embodiment of portal view management system 208 of the present invention. Portal view management system 208 primarily includes a portal view profile manager 602 that manages portal view profiles (described below) configured for and/or by each network administrator to cause the generation of a desired portal view display. Portal view management system 208 also includes a portal view display manager 604 that executes portal view profiles and data miners 204 referenced therein to generate a tailored or customized portal view display. A portal view edit manager 606 enables the network administrator to interact with a portal data miner module to modify the portal view profile. A help display manager 608 displays help files in response to a network administrator's request when such a request is made in connection with a portal data miner module 204 that supports help files. Each of these components of portal view management system 208 is described below.

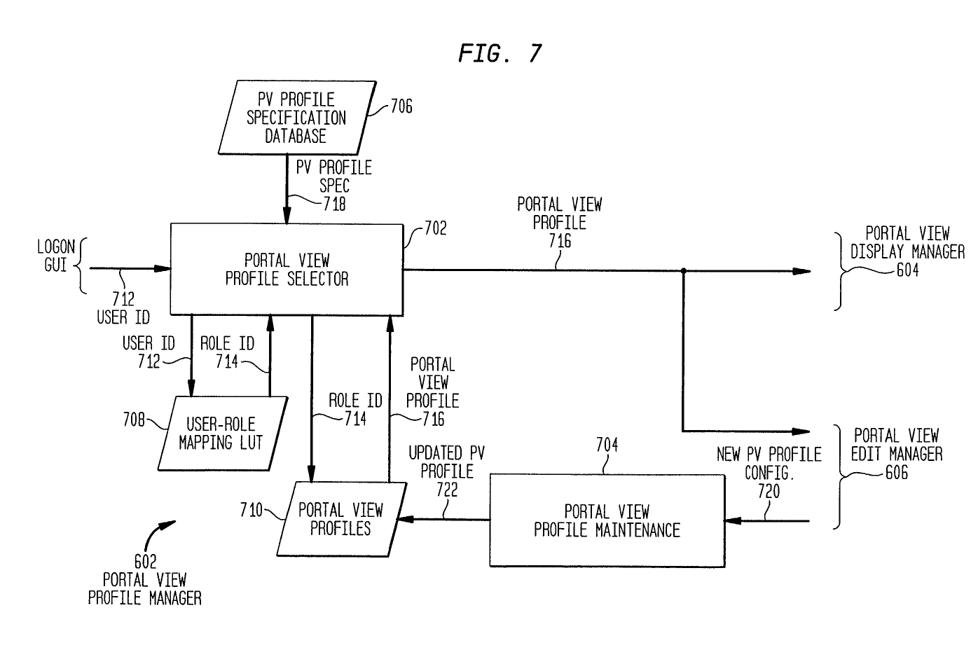

FIG. 7 is a functional block diagram of one embodiment of portal view profile manager 602 of the present invention. Included in portal view profile manager 602 is a database 710 of portal view profiles 716. As will be described in detail below, portal view profiles 716 are generated and stored in database 710 a priori. A portal view profile selector 702 receives user ID 712 and selects one portal view profile 716 specifically configured for and/or by the indicated network administrator. Portal view profile 716 is an extensible, modifiable, executable software program, here in the form of an XML file that references a pre-determined combination of one or more portal data miner modules 204. When invoked, the referenced portal data miner modules generate or cause the generation of selected management information to assist the network administrator manage a partitioned network 142.

There may be occasion where more than one network administrator may utilize the same portal view profile 716. For example, a portal view profile 716 may be designed for a certain group of users, such as all network administrators, in a single company. Thus, the relationship between user ID 712 and portal view profile 716 could be other than a one-to-one relationship and can change over time as user access and networked computing environment 100 change. To address such circumstances, a role ID 714 is associated with each user ID 712 in certain embodiments of the present invention. There may be, as noted, more than one user assigned the same role ID 714.

In such an embodiment, portal view profile manager 602 includes a mapping lookup table (LUT) 708 that includes mappings between user ID 712 and role identifiers (IDs) 714. LUT 708 is accessed by portal view profile selector 702 with user ID 712 and retrieves the associated role ID 714. Portal view profile selector 702 then accesses portal view profile database 710 with role ID 714 to retrieve the appropriate portal view profile 716 for the specific user. In addition to facilitating the sharing of portal view profiles 716 among many network administrators, this embodiment in which an intermediate role ID value 714 is utilized provides profile manager 602 with the capability of changing, adding and otherwise editing the assignments between network administrators and portal view profiles 716 as circumstances change.

The use of a LUT 708 to provide the mappings is advantageous in those environments in which the mappings may change over time since LUTs can be easily populated with new data. In addition, implementing such functionality in a LUT allows for efficient processing. For example, in one embodiment, wildcard matching is implemented to avoid having to enumerate each and every user ID 712. For example, all users from a particular company may have a common component in their user ID 712 which can be used to provide all such users with a single portal view profile 716. In addition, an ID for a default portal view profile 716 can be included in mapping LUT 708 for those circumstances when there is no entry in mapping LUT 708 for the received user ID 712. As one of ordinary skill in the art would find apparent, other functions and operations associated with the use of a LUT-based mapping scheme can be implemented in portal view profile selector 702. Such modifications are considered to be within the scope of the present invention. Thus, upon receipt of user ID 712, portal view profile selector 702 accesses LUT 708 and retrieves role ID 714. Portal view profile selector 702 then accesses database 710 and retrieves the identified portal view profile 716. As shown, this retrieved portal view profile 716 is provided to portal view display manager 604 and portal view edit manager 606.

As shown in FIG. 7, a portal view profile maintenance module 704 is also included in portal view profile manager 602. Portal view profile maintenance module 704 operates with portal view editor manager 606 to enable an network administrator to modify, add or delete the contents of portal view profile database 710. Thus, as the requisite management information changes, a network administrator can specify new portal view profile configuration data 720 which is used by maintenance module 704 to generate an updated portal view profile 722. Thus, in this embodiment, database 710 can be easily modified.

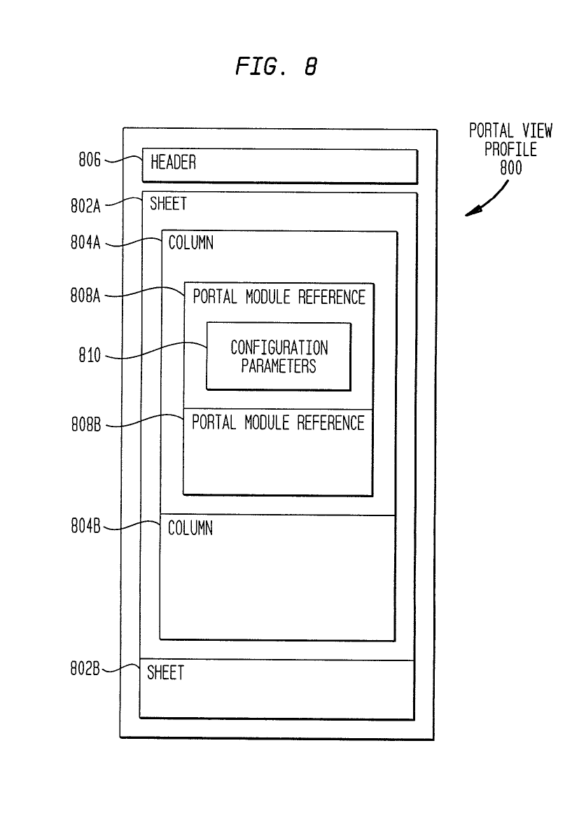

A portal view profile 716 is an executable, extensible file that, when invoked, obtains or generates management information specifically tailored to assist a particular network administrator or group of network administrators manage a computing environment 100. Such a portal view window includes management information obtained by portal data miner modules 204 invoked during the execution of portal view profile 716. FIG. 8 is an architectural diagram illustrating the contents of an exemplary portal view profile 800. The structure of portal view profile 800 reflects the structure of the resulting portal view display. Generally, a network administrator may group the management information into columns that are displayed concurrently, and may group the columns into different sheets that are shown alternatively.

Portal view profile 800 includes header information 806 specifying information that is not related to a particular module display. Sheet display specifications 802 define for one or more sheets each including specifications 804 for one or more columns. Within each column specification there is one or more portal module references 808 to a predetermined combination of data miners 204. Each portal module reference 808 includes portal module configuration parameters 810 that provide attribute settings to the referenced portal view module 204 when it is invoked. As will be described in detail below, such configuration parameters 810 can set attributes related to, for example, the depth and breadth of information requested, the manner in which information is to be analyzed, displayed, etc. Detailed examples of portal view profile 716 are set forth below.

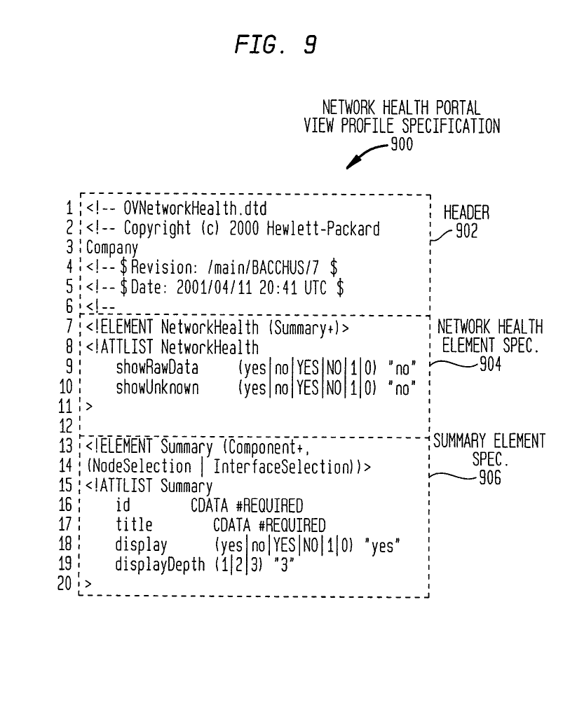

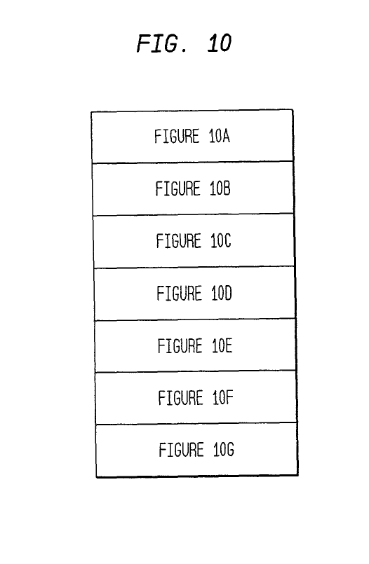

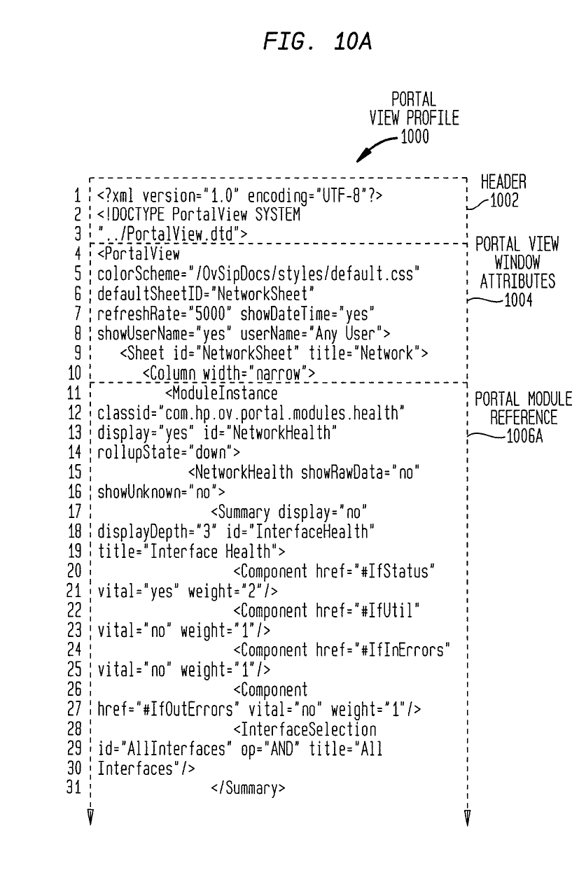

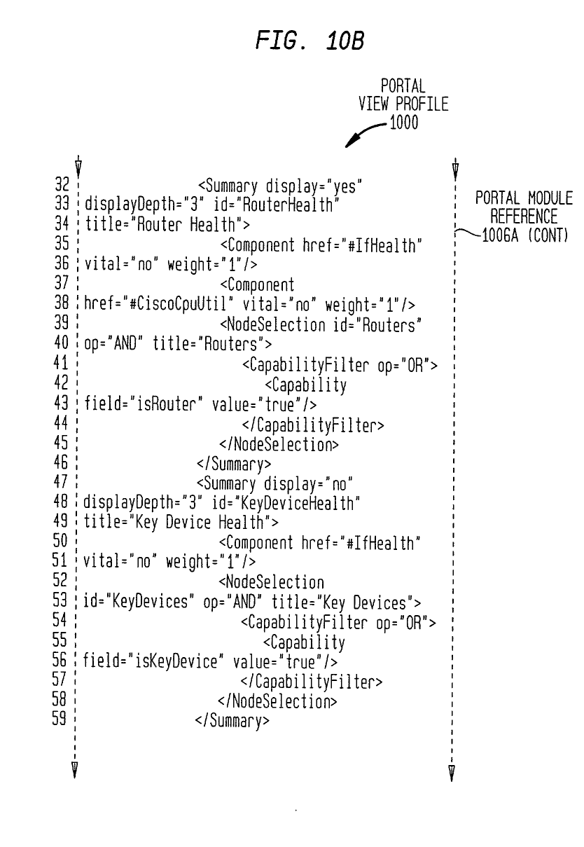

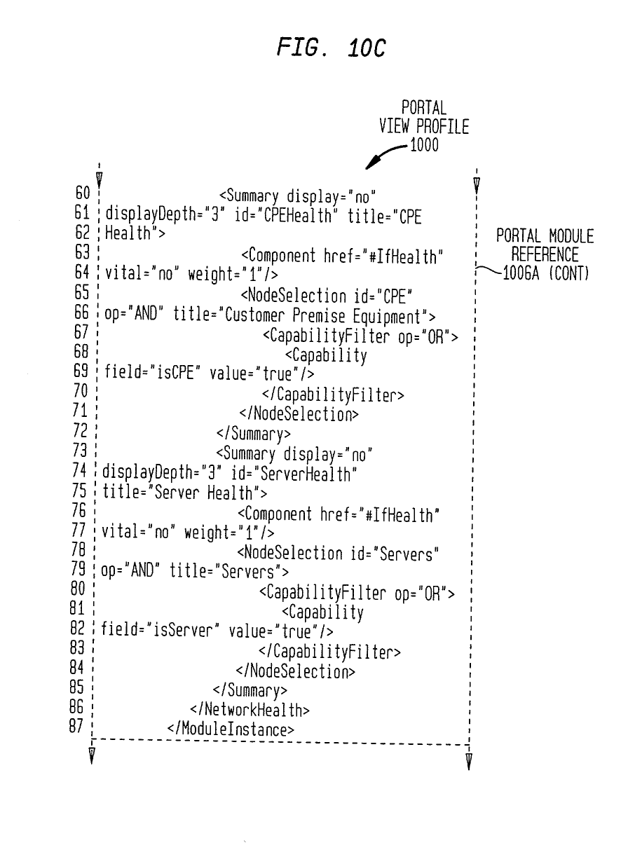

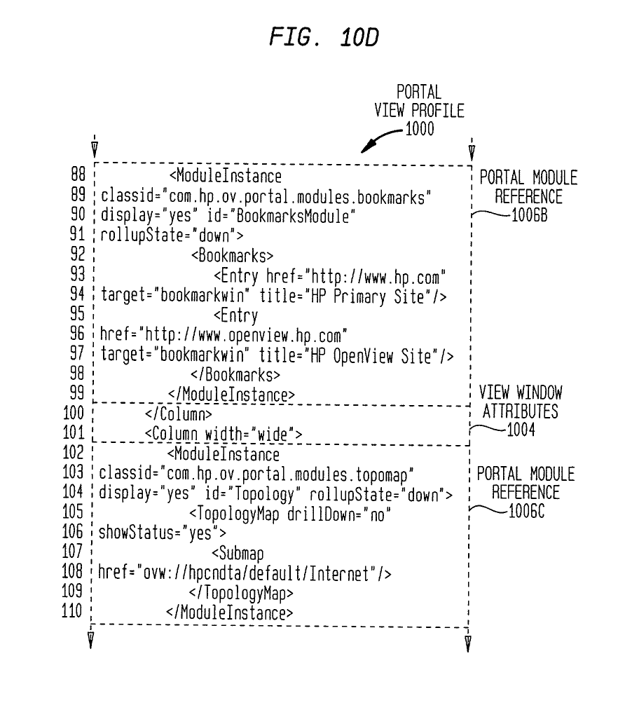

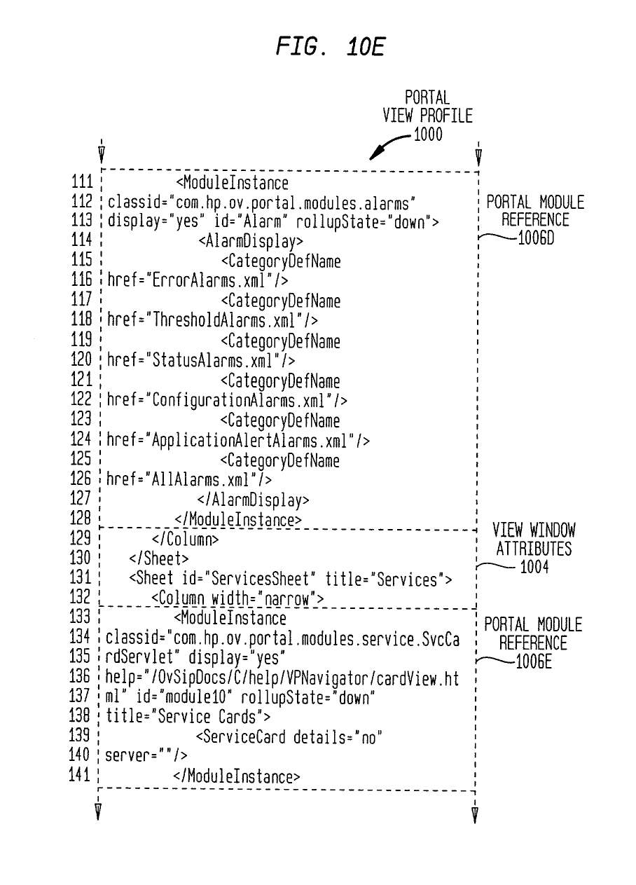

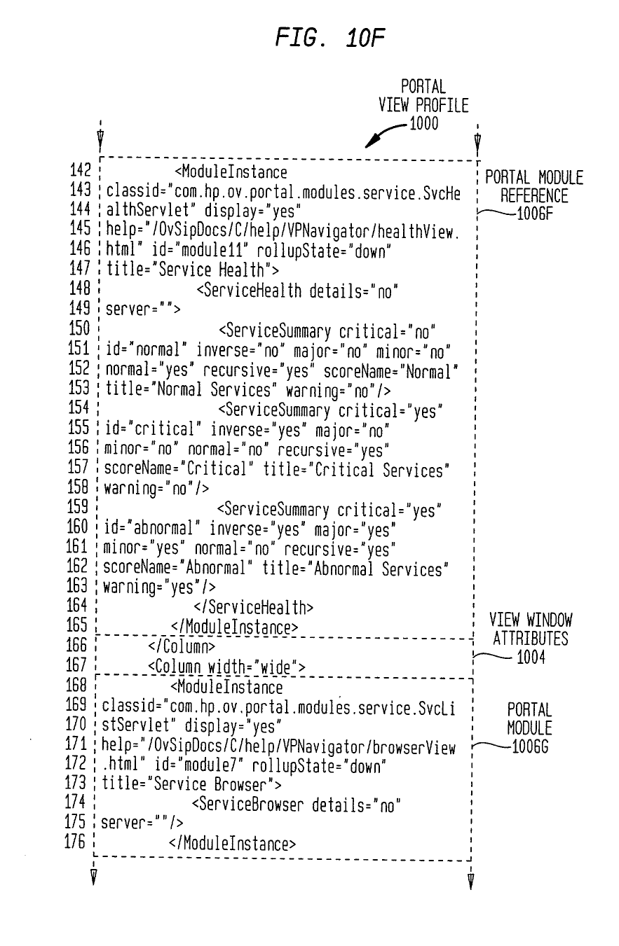

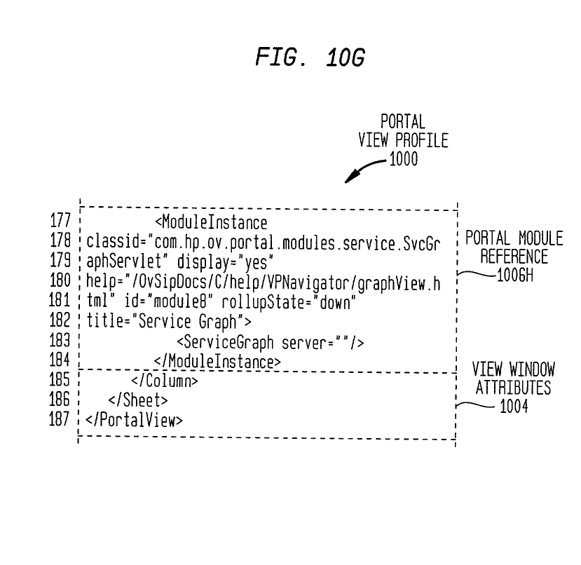

Referring again to FIG. 7, portal view profile selector 702 also accesses a database 706 of portal view specification files 718. Each portal view specification file 718 defines the grammar that is to be used in a portal view profile 716 in connection with a corresponding portal view module 204. FIG. 9 is an exemplary portal view profile specification 718 for a network health portal view module 204. An exemplary portal view profile 716 that includes elements referencing a network health portal module 204 is described below with reference to FIGS. 10A-10G. A portion of portal view profile 1000 references a network health portal module and is consistent with specification file 900. This will be described in detail below with reference to FIGS. 10A-10G.

Referring now to FIG. 9, network health portal view profile specification file 900 is a .dtd file. Lines 1-6 of specification file 900 define a header 902. Header 902 includes typical file header information such as revision data, etc. As shown in FIG. 9, network health portal view profile specification file 900 includes two portions, a network health element specification 904 and a summary element specification 906.

Network health element specification 904 begins at line 7 of specification file 900. Line 7 indicates that each network health element (“ELEMENT NetworkHealth”) includes many summary elements (“Summary+). The attribute list (“ATTLIST NetworkHealth”) for each network health element is specified at lines 8-11 and includes two attributes, one at line 9, the other at line 10. The first attribute indicates whether the referenced network health module is to display the underlying source data extracted from domain managers 224 (“showRawData”). The options are variations of yes and no, with the default being “no”. The second attribute indicates whether the referenced network health module is to include in its determination unknown source data (“showUnknown”). The options are variations of yes and no, with the default being “no”. Network health element specification 904 ends at line 11.

Summary element specification 906 begins at line 13 of specification file 900. Line 13 indicates that each summary element (“ELEMENT Summary”) includes many components (“Components+) and that they can provide a summary of either a node (“NodeSelection”) or node interface (“InterfaceSelection”), as shown at line 14. The attribute list (“ATTLIST Summary”) for each summary element is specified at lines 15-20 and includes four attributes, one set forth at each of lines 16-19. The first attribute specifies the ID for the portal module (“id”) while the second attribute specifies the title to be displayed (“title”). The third attribute at line 18 indicates whether the summary data is to be displayed (“display”). The options are variations of yes and no, with the default being “yes”. The fourth attribute shown at line 19 specifies the depth of data that is to be displayed. As shown by the options, there are three depths that can be specified, each represented by an integer value. The default, as shown in a depth level of “3”.

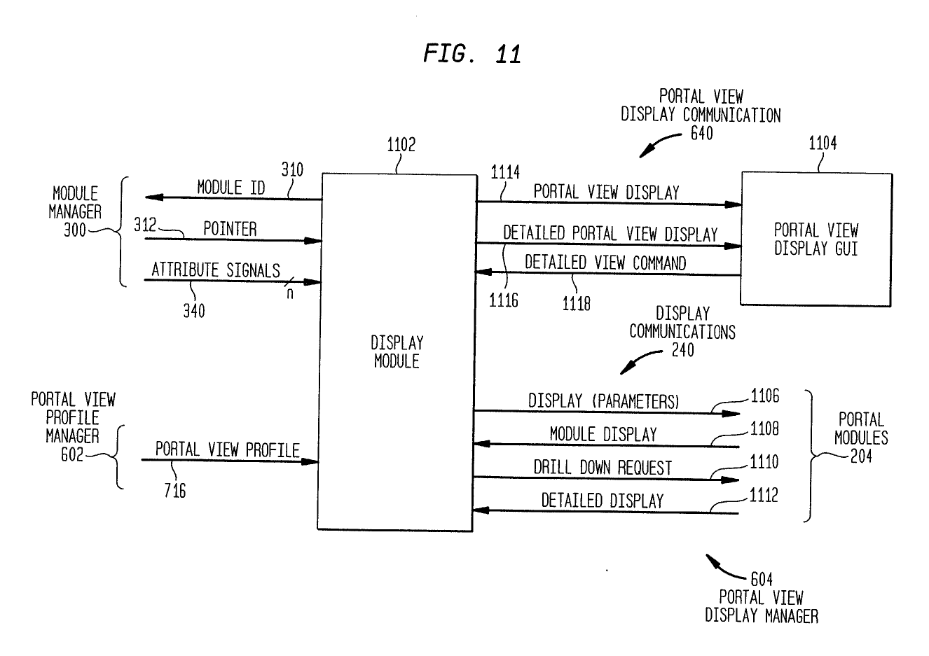

FIG. 11 is a functional block diagram of one embodiment of portal view display manager 604 of the present invention. As noted, portal view display manager 604 retrieves management information from data miners 204 to be displayed through a graphical user interface 1104 in accordance with a portal view profile 716 specifically tailored for the network administrator. Recall that each portal view profile 716 is associated with a network administrator or group of network administrators, and can be created, changed or modified by a network administrator to achieve a desired view of the managed computing environment. Accordingly, the retrieved management information is particularly relevant to assisting the particular network administrator perform desired management functions.

Portal view display manager 604 includes a display module 1102 that loads (that is, executes) the portal view data miner modules 204 read into memory by module manager 300 and referenced by the currently executing profile 716. Each data miner 204 obtains, generates or causes the generation of specific management information, as noted above. The management information is presented to the network administrator through a portal view display GUI 1104 included in portal view display manager 604. Display module 1102 causes display GUI 1104 to display management information generated by portal view data miner modules 716 in accordance with a portal view profile 716. Each of these components is described in detail below.

Display module 1102 receives portal view profile 716 from portal view profile manager 602. In a preferred embodiment and the example shown in FIG. 10, profile 716 is an XML file. Display module 1102 processes portal view profile 716, loading and invoking data miners 204 that are referenced in references 808 in PORTAL VIEW profile 716. Executing data miners 204 access, call, query, or otherwise interface with external sources such as those noted above to retrieve or cause the generation of MI.

Display module 1102 provides module manager 300 with a module ID 310 of each referenced portal view data miner module 204 and receives back a pointer 312 to the memory location in which the executable code for the referenced portal view data miner module 204 is located. Display module 1102 executes the referenced portal view module 204 by generating a display invocation command 1106, likely with one or more parameters specifying various attributes as desired by the network administrator. The executed portal view module 204 performs the noted operations, retrieving the specified management information from the managed objects, and providing the results in the specified format to display module 1102. This return of management information for display is represented by module display 1108 generated by modules 204 and received by display module 1102.

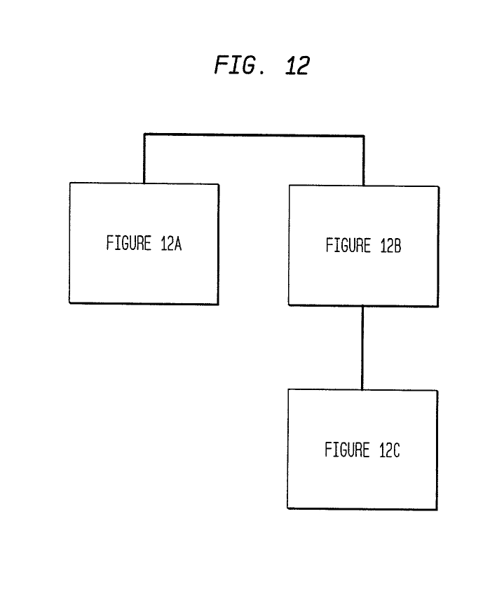

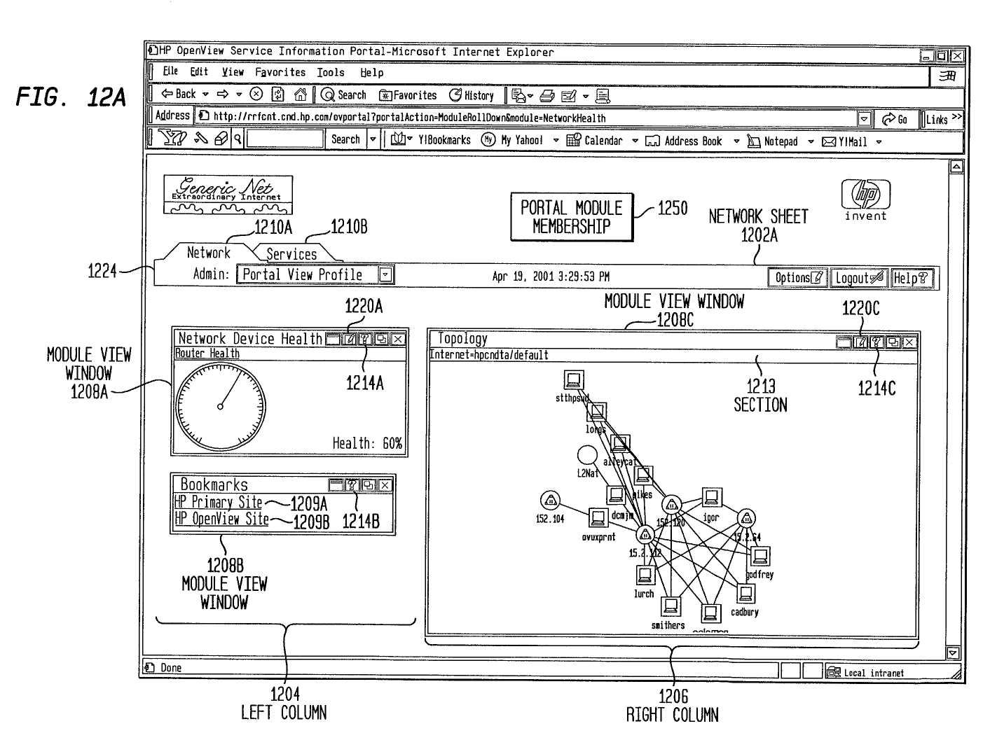

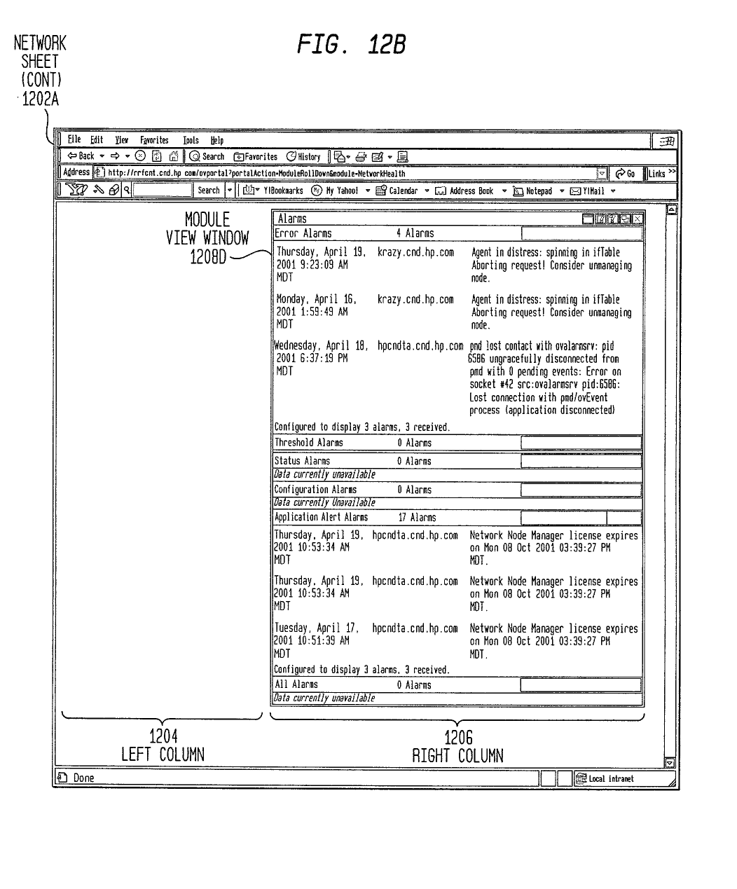

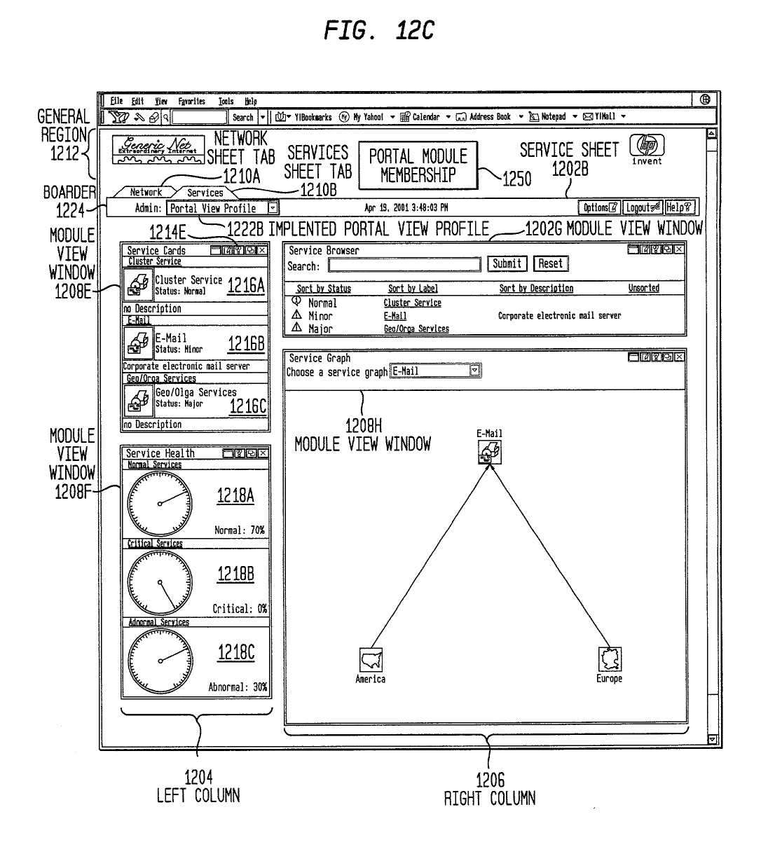

Display module 1102 generates portal view display 1114 that causes a desired portal view to be displayed on display device 212 through portal view display GUI 1104. Portal view display 1114 has an architecture similar to portal view profile 800 described above with reference to FIG. 8. As noted, an exemplary portal view profile 1000 is described below. Included in that description is a description of the resulting portal view display shown in FIGS. 12A-12C.

As will be described in detail below, display module 1102 displays a series of windows each allocated to the display of management information provided by a particular portal module 204. The size of each such window is determined by the output type attributes specified in registration file 308. Each module view window is located within a column as defined by column specification 804 which in turn are included in a sheet as defined in sheet specification 802. In addition, portal view display 1114 includes what is sometimes referred to as decorations such as a region in which general information, advertisements and the like can be displayed. These features of a portal view display 1114 arc described below with reference to the example illustrated in FIGS. 12A-12C.

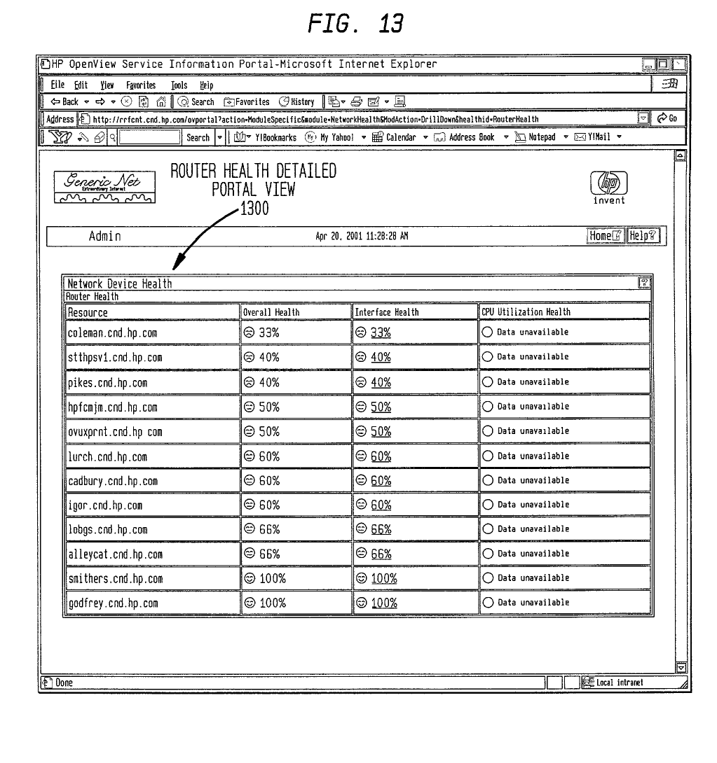

As will be described in detail below, certain portal modules 204 provide an additional view to the network administrator. This view includes a presentation of detailed management information. For example, certain management information may be provided in summary form to the network administrator. Should it be necessary to investigate or analyze that information, the network administrator can request that the supporting information extracted from the managed objects by displayed for closer inspection. This request is shown in FIG. 11 as a detailed view command 1118. In response to this command, display module 1102 generates a drill down request signal 1110 that causes the data miner module 204 to generate the detailed display 112. This detailed display 1112, like the module display 1108, is packaged with additional display data, and is presented to GUI 1104 as detailed portal view display 1116. FIG. 13 is an exemplary detailed portal view display 1116 described in detail below. This particular view provides detailed information presented in the network health view window illustrated in FIG. 12.

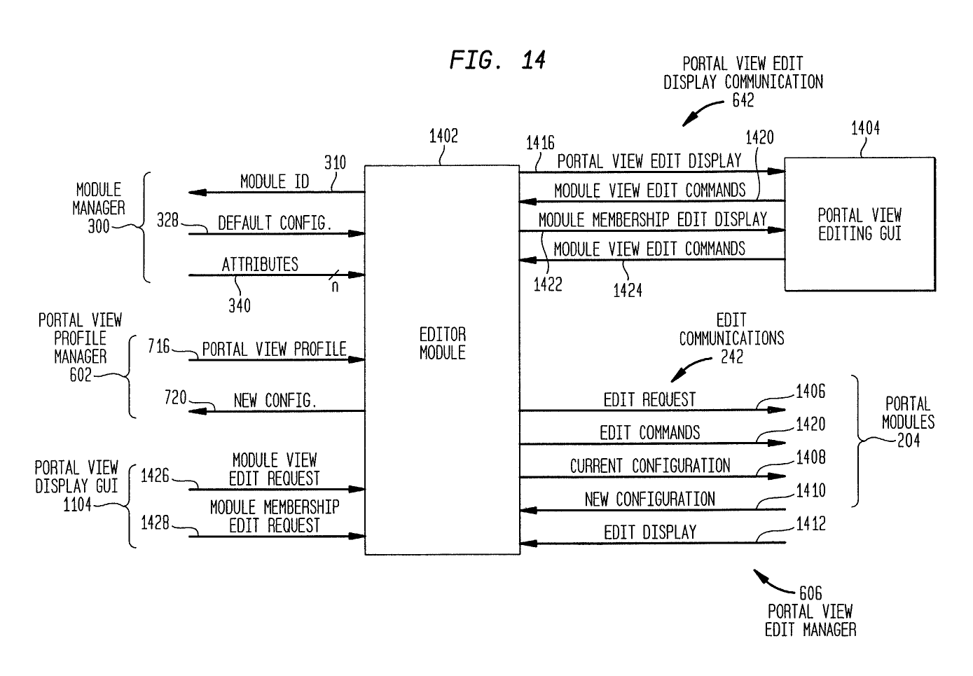

FIG. 14 is a functional block diagram of one embodiment of portal view edit manager 606 of the present invention. Portal view edit manager 606 includes a editor module 1402 that facilitates the modification of which portal modules 204 are invoked and have the results of their operations displayed in portal view display 1114. In addition, editor module 1402 enables the network administrator to modify the attributes for the referenced data miner module 204 to achieve a desired view 1114 of the management information generated by the module 204. Editor module 1402 displays editing windows or views through a portal view editing graphical user interface (GUI) 1404 that includes a user interface through which the network administrator can make editing commands. Each of these components is described in detail below.

Editor module 1402 is invoked when the network administrator makes an entry that indicates a desired to edit a portal view window. As described elsewhere herein, display is module 1102 displays in each module view window 1208 an edit icon when the registration file 308 for the corresponding portal module 204 includes an affirmative indication for the edit attribute (see lines 22 and 23 of specification file 400 illustrated in FIG. 4).

When the user graphical selects this edit icon, portal view display GUI 1104 generates an module view edit request 1420 that is received by editor module 1402. In response, editor module 1402 generates an edit request 1406 to the portal module 204 associated with the portal view window 1208 on which the edit icon is displayed. With edit request 1406, editor module 1402 also provides portal data miner module 204 with the current configuration 1408 implemented in the portal view profile 716 for this network administrator. This information is retrieved from portal view profile 716 provided by portal view profile manager 602.

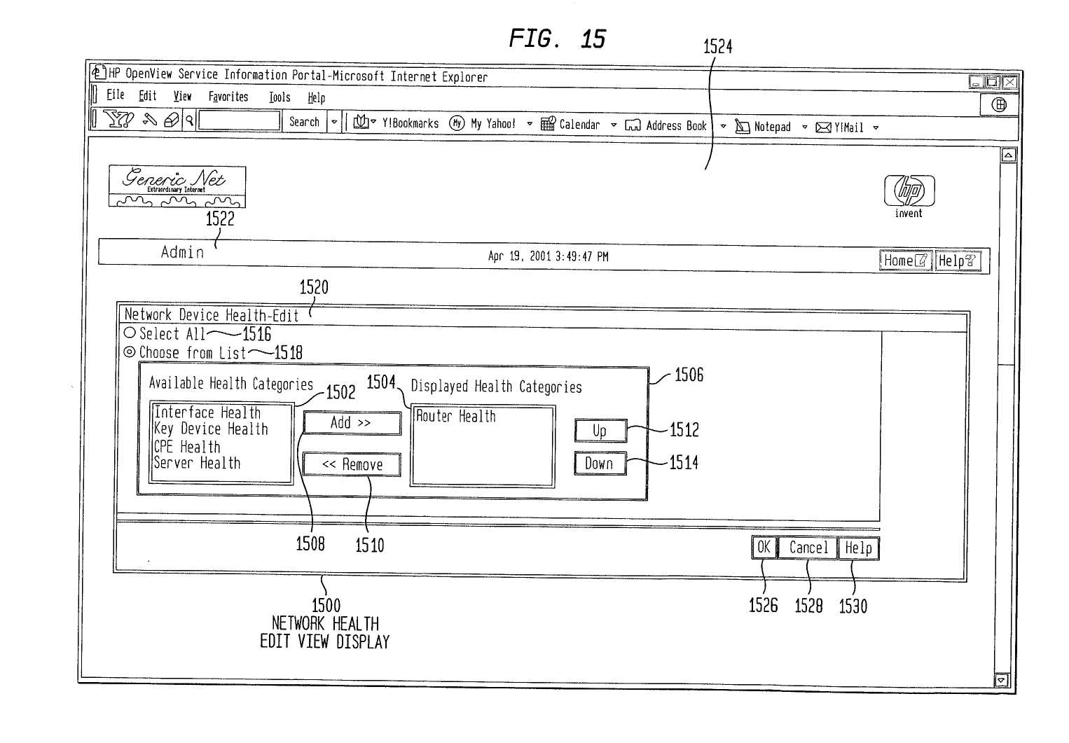

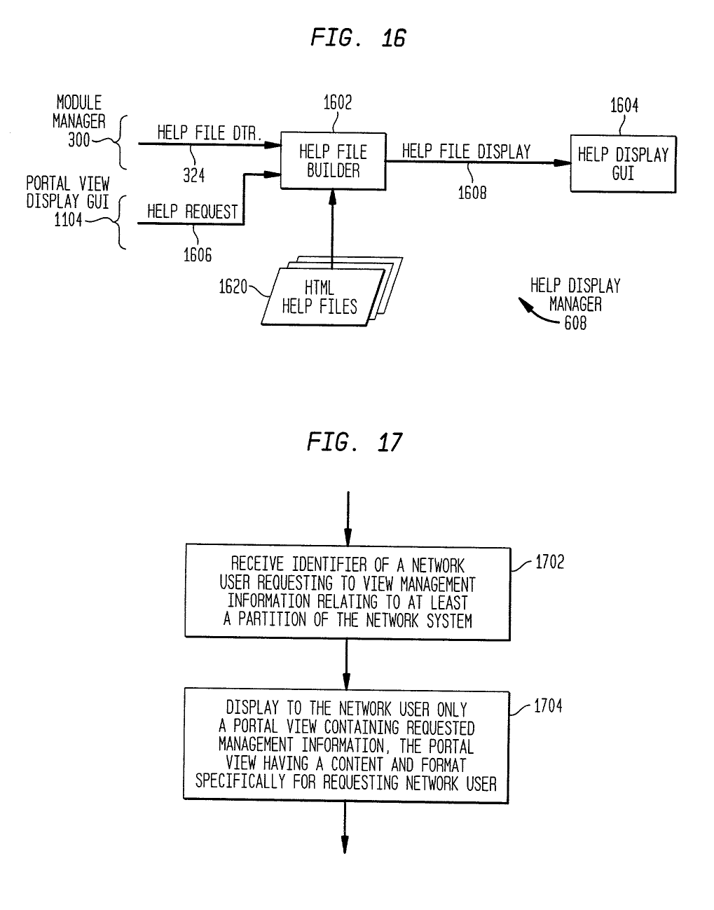

Portal data miner module 204 generates an edit display 1412 which editor module 1402 packages with other display data and provides to GUI 1404 as edit view display 1416. FIG. 15 illustrates one example of an edit view display 1416 for a network health portal module 204. Through this edit view display 1416 the network administrator makes selections appropriate for the particular data miner module 204. These modifications are represented by edit commands 1420 in FIG. 14 generated by GUI 1404. Editor module 1402 forwards these edit commands 1420 to data miner module 204. Portal module 204 revises the current configuration to arrive at a new configuration 1410 that is provided to editor module 1402. This new configuration information is provided to portal view profile manger 602 which, as noted, generates and stores a new portal view profile 716 incorporating the new configuration. This exemplary edit display window 1500 is described in detail below.

Referring now to FIG. 15, network health edit view display 1500 is a view window provided in an administrative portal view sheet 1522 by editor module 1402. Along with the administrative view sheet 1522 editor module 1402 also displays generic information in a header region 1524. As noted, this provides service provider 130 to present information to the network administrator.

Network health edit view display window 1500 provides a listing display box 1506 in which a list 1502 of available health categories is displayed adjacent to a list 1504 of currently displayed health categories. Interposed between these adjacent listings 1502, 1504 are Add and Remove display buttons 1508, 1510. Highlighting a health category in available health category list 1502 and selecting add display button will cause editor module 1402 to add the selected health category to the list 1504 of displayed heath categories. Similarly, highlighting a health category in displayed health category list 1504 and selecting remove display button 1510 will cause editor module 1402 to remove the selected health category from list 1504 of displayed heath categories and add it to list 1502 of available health categories. If either list 1502, 1504 has more health categories than can be viewed in the associated window, the user is provided with the capability of scrolling through the list by selecting the up and down display buttons 1512, 1514.

In this illustrative embodiment, network health edit view display window 1500 also includes alternate display selections 1516 and 1518. To select all of the available health categories 1502, the user can click on the “Select All” entry 1516. Otherwise, the user clicks on the “Choose from List” entry 1518 and then proceeds to the listing display box 1506 to perform the operations noted above.

Once the user has identified the health categories that the user desires to have displayed in a network health module view window, the operator selects the OK button 1526. Alternatively, the user can graphically select the cancel button 1528 to close edit view window 1500 without entering any changes that may have been made. A help button 1530 is provided to invoke a well known help function to assist the user in the efficient utilization of network health edit view display window 1500. The above and similar graphical operations associated with the juxtaposed list arrangement illustrated in FIG. 15 are considered to be well known in the art.

As noted, editor module 1402 also enables the network administrator to modify the portal modules 204 that are referenced in a portal view profile 716 and for which there is a corresponding module view window 1201 displayed in portal view display 1114. As noted, portal view display 1114 includes a display button 1250 entitled “Portal Module Membership”. Selection of button 1250 causes portal view display GUI 1104 to generate a module membership edit request 1422 that is received by editor module 1402. In response, editor module 1402 displays a module membership edit display 1422 through editing GUI 1404. Such a display can be any display arrangement that provides the network operator with a listing of the available portal modules 204 that can be included in a portal view display 1114. For example, the display can be similar to that shown in FIG. 15, with an available list of data miner modules 204 displayed adjacent to a currently displayed list of data miner modules 204. The network administrator can add and remove portal modules as described above.

If the network administrator adds a portal module, editor module 1402 provides module manager 300 with the module ID 310. Module manager 300 provides editor module 1402 with a pointer 328 to a default configuration. Editor module 1402 then provides the default configuration to portal view profile manager 602 as part of a new configuration 720.

FIG. 17 is a functional block diagram of one embodiment of help display manager 608 of the present invention. Help display manager 608 includes a help builder module 1702 and a help display graphical user interface (GUI) 1704. As noted, a prtal view display 1114 includes a help icon in each module view window 1210 for which the associated registration file 308 has a help attribute designating a help file 1720 (see line 24 of module registration file specification 400 illustrated in FIG. 4).

Display GUI 1104 generates a help request in response to the selection of the help icon. Help builder 1702 retrieves an HTML help file 1720 identified by the path 324 provided by module manager 300. As noted, module manager 300 retrieves the help pointer from the registration file 308 for the portal module 204. Help file builder 1702 generates a help file display 1708 through help display GUI 1704. Help file display 1708 includes primarily the retrieved help file 1702.

Other techniques for providing a help display can be used in conjunction with or in place of a text file. For example, in one embodiment, the portion of help file 1720 that is displayed is based on the context of the operations recently performed by the network operator. In another embodiment, help file 1720 is an interactive, hypertext file that provides the network administrator with information at any desired level of detail.

FIG. 17 is a high-level flow chart of the operations performed by service information portal 126 in accordance with one embodiment of the present invention. At block 1702 an identifier of a network user is received. The network user is requesting to view management information relating to a partitioned network 142. Such as user, as noted, is typically a network administrator responsible for the ongoing management of partitioned network 142.

In response to the request received at block 702, service information portal 126 displays at block 704 to only the requesting user a portal view containing the requested management information. The portal view displayed to the user is configured for this particular user and contains information pertinent only to the partitioned network 142 for which this user is responsible or otherwise has authorized access. The format and content of the portal view arc also configured for this particular user. All aspects of the portal view can be configured for or by the user. For example, which management information is to be displayed can be selected by the user. In addition, the level of detail in which the management information is displayed is also an aspect of the portal view that can be configured for or by the user. In addition, the format and arrangement of the presented management information can also be configured. Thus, a completely personalized, tailored portal view into the partitioned network 142 is provided to the requesting user.

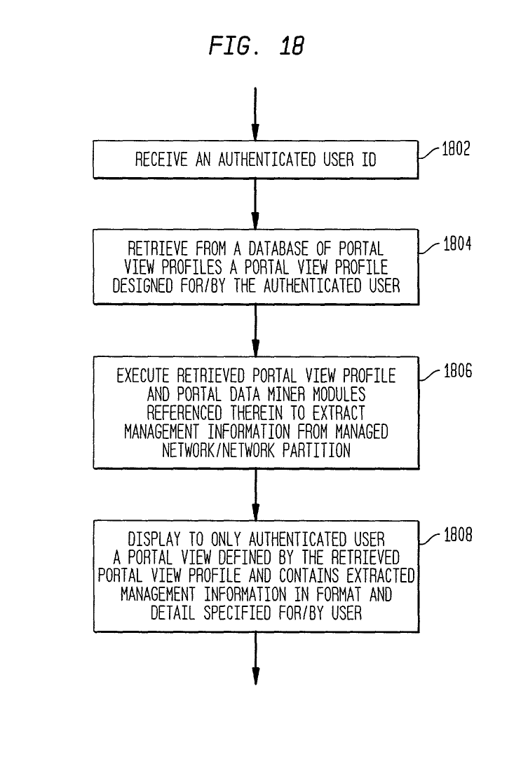

FIG. 18 is a more detailed flow chart of the processes performed by service information portal 126 at block 1704 in accordance with one embodiment of the present invention. At block 1802, identification information for a user that has been authorized to have access to the service information portal 126 is received.

A database of portal view profiles is maintained by service information portal 126. Each such portal view profile is an executable file that is specifically designed to provide the management information noted above with reference to block 704 of FIG. 7. At block 1804 a portal view profile associated with this particular user is retrieved from the database of portal view profiles. This retrieved portal view profile is designed for or by this user or a group of users that includes this particular user.

The retrieved portal view profile is executed at block 1806. Each portal view profile references one or more portal data miner modules. Each portal data miner module extracts or generates specific management information about the partitioned network 142. Typically, the portal data miner module extracts data from management systems in the network system 100.

This extracted management information is displayed to this user only at block 1808. The portal view display is defined by the retrieved portal view profile and contains management information in a format and level of detail specified for or by this user. Thus, the resulting portal view display includes management information specifically designed for or by the user. The management information is presented at a level of detail specified for or by the user. The format and arrangement of the displayed management information is also designed for or by the user. Thus, service information portal 126 provides the user with a completely tailored and customizes view of specified management information to assist the user manage at least a partitioned network 142.

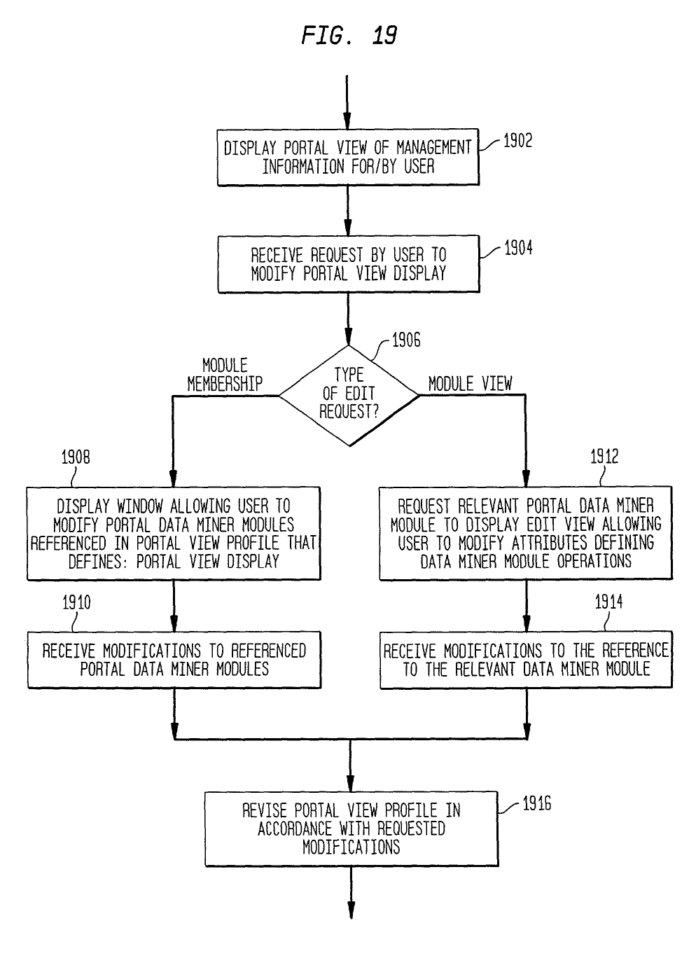

FIG. 19 is a flowchart of the processes performed in accordance with one embodiment of service information portal 126 of the present invention to edit a portal view display. At block 1902 a portal view display is presented to a user. The operations entailed to provide such a display are described above. A request by the user to modify the portal view display is receive at block 1904. Although in this example the portal view display to be modified is displayed at the time the request is received, this need not be the case. In any event, there are two types of modifications to the substantive management information that can be made to a portal view display. In other words, the portal view profile that generates the portal vie display can be modified in any way desired, with such modifications including the layout and management of module view windows in which management information is displayed. Beyond this, however, there are modifications that can be made to the displayed management information. Which type of modification is determined at block 1906.

If at block 1906 it is determined that a modification to the module membership is desired, processing continues at block 1908. Here, service information portal 126 displays a window through which the user can modify which portal data miner modules are referenced by the portal view profile that generates the portal view display. The results of the modifications are received at block 1910 are used to revise the portal view profile at block 19196.

If at block 1906 it is determined that a modification to a module view is desired, processing continues at block 1912. Here, service information portal 126 facilitates the modification by requesting that the relevant portal data miner module display an edit window through which the user can make the desired modifications. The user makes such modifications which are received at block 1916 and are used to revise the portal view provide at block 1916.

IV. Examples

As noted above, FIGS. 10A-10G together illustrate an exemplary portal view profile 1000 while FIGS. 12A-12C together illustrate aportal view display 1200 resulting from the execution of portal view profile 1000 by service information portal 126. FIG. 12 is an illustration of the relationship between FIGS. 12A-12C. In addition, FIG. 13 is a detailed portal view display 1300 displayed by service information portal 126 when the user requested more detailed information than that shown in one module view window shown in FIG. 12. These examples will now be described below. Addition descriptions of these and other examples can be found in U.S. patent application entitled “DYNAMIC GENERATION OF CONTEXT-SENSITIVE DATA AND INSTRUCTIONS FOR TROUBLESHOOTING PROBLEM EVENTS IN INFORMATION NEWORK SYSTEMS”, filed on Apr. 30, 2001 under Attorney Docket No. 10992465-1 and U.S. patent application entitled “SYSTEM AND METHOD FOR MANAGING DATA MINER MODULES IN AN INFORMATION NETWORK SYSTEM”, filed on Apr. 30, 2001 under Attorney Docket No. 10015949-1, the specifications of which are hereby incorporated herein by reference in their entirety. It is important to recall that these are examples only and that there are numerous other portal data miner modules 204 that can be utilized by the present invention. Furthermore, portal view management system 208 provides a view window in the portal view display into which the referenced data miner module draws the management information specified by the network administrator in an edit view provided by the data miner 204. The results of such specifications are provided to portal view management system 208 for inclusion in profile 716. Thus, the detailed control of data miners 204 varies. A few examples are provided hereinbelow and in the applications incorporated by reference.

Referring now to FIGS. 12A-12G, the exemplary portal view profile 1000 is in XML format. Portal view profile 1000 is segregated into header information 1002, attributes 1004 and portal module references 1106. This portal view profile 1000 has a format consistent with that shown in FIG. 8 and described above. Portal view display 1200 is also configured in a manner consistent with the profile format shown in FIG. 8, with 2 sheets of management information each divided into columns with each column having a series of module view windows.

Lines 1-3 of portal view profile 1000 include standard header information for an XML document, identifying the version and type of document. The content and format of header 1002 are well known. Portal view display 1200 is divided structurally into sheets 1202. There is a “Services” sheet 1202A (FIG. 1202A) and a network sheet 1202B (FIGS. 12B and 12C). Each sheet in turn is divided into columns. In the example shown, there are two columns, a left column 1204 and a right column 1206. Each column 1204, 1206 can have any number of module view windows 1208 displayed therein. This structure is consistent with the structure of portal view profile 1000, described above with reference to FIG. 8. That is, each portal view profile includes sheet attributes 082 and column attributes 804. These attributes are set forth in exemplary portal view profile 1000, and are generally referred to as portal view window attributes 1004. Portal view window attributes 1004 include attributes that define the format and content of the portal view window other than the contents of the module view windows 1208 displayed therein.

Referring now to FIGS. 10A-10G, portal view window attributes 1004 are shown at lines 4-10 (FIG. 10A), lines 100-101 (FIG. 10D), lines 129-132 (FIG. 10E), lines 166-167 (FIG. 10F) and lines 185-187 (FIG. 10G). In this illustrative embodiment, these attributes are identified by the element “PortalView” and include information such as the color scheme (colorScheme=/OvSipDocs/styles/default.css”) at line 5, the view window sheet identifier (defaultSheetID=“NetworkSheet”) at line 6 and refresh rate (refreshRate-“5000”) at line 7. At lines 7 and 8 the date and user name are set to appear (“showDateTime=“yes”; and “showUserName=“yes”). In portal view display 1200, these values appear in the boarder 1224 of each sheet 1202.

The first sheet is defined at line 9 (Sheet id=“NetworkSheet”) along with the displayed name “Network” (title=“Network”) for display. In this illustrative embodiment, The sheets 1202 are presented as tabbed windows. The specified title is shown in the body of tab 1210 of network sheet 1202A, as shown in FIG. 12A. This code for this Network Sheet extend to line 129 of portal view profile 1000 shown in FIG. 10E (</Sheet>”). The code encompassed between lines 9 and 129 define the format and contents of the network sheet displayed in FIGS. 12A and 12B. This will be described in detail below.

Similarly, the second sheet is defined at line 130 (Sheet id=“ServicesSheet”) along with the displayed name “Services” (title=“Services”) for display in tab 1210B of sheet 1202B, as shown in FIG. 12C. This code for this Services Sheet extend to line 186 of portal view profile 1000 shown in FIG. 10G (</Sheet>”). The code encompassed between lines 130 and 186 define the format and contents of the Services Sheet displayed in FIG. 12C.

Returning now to FIG. 10A and the portal view window attributes 1004 at lines 4-10, the format of the Network Sheet 1202A shown in FIGS. 12A and 12B will now be described. As noted, Network Sheet 1202A is divided into two columns, a left column 1204 and a right column 1206. The attributes to establish this column arrangement are provided at lines 10 (FIG. 10A), lines 100-101 (FIG. 10D) and line 129 (FIG. 10E). In this example, the first column is a narrow column, defined at line 10 (“<Column width=“narrow”>”). This column includes the module view windows for each portal data miner module 204 referenced between lines 10 and 100. The second column is a wide column, defined at time 101 (“<Column width=“wide”>”). This column includes the module view windows for each portal data miner module 204 referenced between lines 101 and 129. The same arrangement is presented for the Services Sheet (FIG. 12C) as shown at lines 132 (FIG. 10E), 166-167 (FIG. 10F) and line 185 (FIG. 10G).

Displayed in the narrow left-hand column 1202 are module view windows 1208A and 1208B defined by the portal module references 1006A and 1006B, respectively. As noted each such data miner module reference 1006 includes configuration parameters 810 (FIG. 8) defining the attributes to be used by the referenced data miner module 204, and satisfies the requirements of the corresponding portal view profile specification 718 (FIG. 7) for the referenced data miner module 204.

Each data miner module reference 1006 is segregated into a block of XML code. This block structure of XML code begins with an element “<ModuleInstance” and ends with the corresponding XML line of code “<ModuleInstance>.” There are a series of attributes included in “<ModuleInstance” that define each instance of the invoked portal data miner module 204. The attributes include a unique portal data miner module identifier (“classid”) that uniquely identifies the referenced portal module 204. This is the portal data miner module defined by the “implementation” attribute of the module registration file 308 (see specification file 400 illustrated in FIG. 4). This is followed by one or more parameters that identify general as well as specific attributes including, for example, display formats, location of help files, etc. As one of ordinary skill in the art would find apparent, these attributes can and will vary for different portal data miner modules 204. Included within each module reference 1006 there are one or more configuration parameters 810 that are passed to the referenced portal data miner module 204 when that module is invoked. These configuration parameters 810, as noted, specify the functions to be performed by this implementation of the referenced data miner module 204, including but not limited to, the type and breadth of management information to be extracted. This too will vary depending on the type of data miner module 204, type of domain manager 224, among other factors. Specific examples shown in XML portal profile 1000 will now be described.

Referring to FIG. 10A, the first portal module reference 1006A invokes a portal data miner module 204 that accesses a number of databases on network system 100 to determine the health of the underlying network system 100 or partition 142 thereof. This particular portal data miner module 204 determines the single value indicative of the health for a specified component or system in network 100.

This data miner module 204 generates an overall graphic such as a gauge, bar graph or the like indicating the overall health of the network, as reflected by specified characteristics. Generally, health indicators provide a view of the current state of the specified system, whereas reports provide historical information. For example, if an email server fails, a health indicator reflecting the health of the other email systems. In another example, when a network fails, a health indicator of the surrounding network nodes may be desired. Generally, the data miner 204 accesses the domain managers responsible for the nodes of interest to obtain such information. One suitable data miner module 204 for displaying the health of a group of entities, systems or services in network system 100 is disclosed in U.S. patent application entitled “METHOD AND APPARATUS FOR CUSTOMIZABLY CALCULATING AND DISPLAYING HEALTH OF A COMPUTER NETWORK”, filed on Jan. 17, 2001 under Attorney Docket No. 10006622-1, the disclosure of which is hereby incorporated by reference herein in its entirety. This portal module reference 1006A includes lines 11-87 of portal view profile 1000, as illustrated in FIGS. 10A and 10B. The resulting module view window 1208A displayed by service information portal 126 in response to the processing of this block of code is shown in FIG. 12A.

The module instance attribute parameters include the unique data miner (classid=“com.hp.ov.portal.modules.health”), that the results are to be displayed (display=“yes”), the internal instance identifier (id=“NetworkHealth”) and the display window display element (rollupState=“down”). The two attributes specified in network health portal view profile specification 900 (see lines 9 and 10 of file 900 shown in FIG. 9) are set at lines 15 and 16 of portal view profile 1000. For this data miner module 204, the parameters include a request that detailed information pertaining to network health determination not be provided (showRawData−“no”). Also, there are some devices that have an unknown state. In this example, such devices are not included in the health determination (showUnknown=“no”).

As noted with reference to specification file 900, each network health module instance can have multiple summary elements (see line 7 of file 900 in FIG. 9). These summary elements are set forth starting at line 17 of profile 1000. Each summary element includes the attributes noted above with reference to specification file 900. The summary elements included in this network health module instance are Interface Health, (lines 17-31), Router Health (lines 32-46), Key Device Health (lines 47-59), CPE Health (lines 60-72) and Server Health (lines 73-85). One of the attributes noted above is the display attribute. Of the five summary elements defined, only one, Router Health, has the display attribute set in the affirmative. As a result, only that summary is shown in the corresponding module view window 1208A (FIG. 12A).

As noted with reference to specification file 900, each summary element is composed of one or more components (see line 13 of file 900 in FIG. 9). For each summary element one or more components and the weight assigned to that component is defined. It should be appreciated that each such component corresponds with an SNMP variable of which there are thousands, and that any number and combination of components can be specified to contribute to the health determination.

Referring to FIG. 12A, portal view window 1208A has a title of “Network Health” in accordance with the attribute specifications in the module registration file 500 (FIG. 5). The next line in view window 1208A is the title specified at line 34 of profile 1000, “Router Health”. A single gauge and associated numerical display is shown indicting that the overall health of the specified system, as reflected in the selected component(s), is 60%.

As noted, certain portal modules 204 provide an additional view to the network administrator. This view includes a presentation of detailed management information. For example, certain management information may be provided in summary form to the network administrator. Should it be necessary to investigate or analyze that information, the user can request that the supporting information extracted from the managed objects by displayed for closer inspection. Referring to FIG. 9, the network health view profile specification 900 includes a display depth attribute level for each summary element. The default is set to provide the most detailed view (“3”; see line 19 of file 900 in FIG. 9). This attribute is set to “3” at line 3 of profile 1000. This enable the referenced data miner module 204 to provide a detailed view when requested by the network administrator. As shown in FIG. 12A, the title “Router Health” is displayed as a link. When the Network Administrator graphically selects the link, a detailed view command 1118 (FIG. 11) is generated. In response to this command, display module 1102 generates a drill down request signal 1110 that causes the network health portal module 204 to generate the detailed display 1112. FIG. 13 is an exemplary detailed portal view display 1300. As shown therein, detailed view 1300 provides additional supporting information that resulted in the health determination shown in FIG. 12A. The left column identifies each router considered while the remaining columns provide the health of each of the components specified in profile 1000.

The next portal module reference 1006B invokes a data miner module 204 that references predetermined report generators located on domain managers 216. This type of data miner 204 causes the generation of relevant reports selected for or by the network administrator. Many domain managers 216 generate reports such as reports providing information regarding network utilization, CPU utilization, etc.

This module reference 1006B includes lines 88-99 of profile 1000, as illustrated in FIG. 10D. The module instance attributes parameters are similar to those noted above in connection with module references 1006A. These include the unique data miner (classid=“com.hp.ov.portal.modules.bookmarks”), that the results are to be displayed (display=“yes”), the internal instance identifier (id=“BookmarksModule”), the display window display element (rollupState=“down”) and the title to be displayed on the portal view window 1208B (title=“Bookmarks”). Referring to FIG. 12A, the resulting portal view window 1208B generated by portal view management system 208 is shown in left column 1204.

After the element indicating the beginning of a list of reports (<Bookmarks>), the referenced data miner module 204 provides the URL for each of two report generators each identified with the syntax “<Entry . . . />”. Within each entry there is a URL to the report generator, a location to send the report, and the title of the displayed link to the URL. For example, selection of the link 1209A, entitled “HP Primary Site” per lines 93 and 94 of profile 1000, invokes a report generator (“http://www.hp.com”) that provides a separate view of that web site.

When invoked by the network administrator, certain report generators generate a report that can provide a large quantity of detailed information in a separate display window. Thus, a profile 716 can include certain such report generator URLs that are relevant to a particular management task.

The next portal module reference 1006C invokes a data miner module 204 that generates a topology map in accordance with the specified parameters. One suitable portal data miner module 204 for displaying the topology of a partition 142 of network system 100 is disclosed in U.S. patent application entitled “DYNAMIC GENERAT10N OF CONTEXT-SENSITIVE DATA AND INSTRUCTI0NS FOR TROUBLESHOOTING PROBLEM EVENTS IN INFORMATI0N NEWORK SYSTEMS”, filed on Apr. 30, 2001 under Attorney Docket No. 10992465-1, the disclosure of which is hereby incorporated by reference herein in its entirety. This module reference 1006C includes lines 102-110 of profile 1000, as illustrated in FIG. 10D. Refining to FIG. 12A, the resulting portal view window 1208C generated by portal view management system 208 is shown in right column 1206.

Here, the passed parameters include a instruction not to provide lower level details of the topology map (TopologyMap drillDown=“no”), to show the status of the displayed nodes (showStatus=“yes”), and to show the specified submap (Submap href=“ovw://hpcndta/default/internet”). Referring to FIG. 12A, the resulting topology portal view window 1208C has a title “Topology” as specified in the corresponding module registration file 308, and a section 1213 corresponding to the specified submap, with a section title of “Internet-hpcndta/default”.

The next portal module reference 1006D invokes a data miner module 204 that retrieves alarm data. This module reference 1006D includes lines 111-128 of profile 1000, as illustrated in FIG. 10E. Referring to FIG. 12B, the resulting portal view window 1208D generated by portal view management system 208 is shown in right column 1296. The module instance attributes parameters are similar to those noted above in connection with other module references. The module instance is defined at lines 111-113.

The corresponding data miner module 204 provides all recent alarms as categorized by the network administrator. Here, the network administrator specified error alarms, threshold alarms, status alarms, configuration alarms, application alert alarms and all alarms. Each of these categories is defined in profile 1000 at lines 114-126, and are allocated a section of module view window 1208D. This relevant alarm information is displayed in each section of window 1208D under the specified section title. As shown therein, the topology data miner module 204 includes the total number of alarms in the specified category, the 3 most recent alarms in each category, and a color bar indicating the significance of the alarms in that category.

As noted above, this exemplary profile 1000 is configured such that management information is divided into two sheets that are displayed separately. Network sheet 1202A was described above with referenced to FIGS. 12A and 12B and the corresponding portions of portal view profile 1000 illustrated in FIGS. 10A-10E. The Networks sheet ends at line 1230 of profile 1000 and the second sheet, Services, is specified at line 131.

The first portal module reference 1006E for this sheet is located at lines 133-141 of profile 1000. The XML line of code at line 13 “<ModuleInstance” indicates the beginning of this module reference block of code 1006E. The module instance attributes are similar to those noted above, including the object class (classid=“com.hp.ov.portal. modules.service.SvcCardServlet”), the display attributes (display=“yes”, rollupState=“down”) indicating how to display the data provided by the referenced module 204, followed by an internal identifier for this instance of the data miner (id=“module10”). One options that can be provided is that the help file identified in the corresponding registration file 308 for this data module 204 can be replaced with a different help file. This is shown at lines 136-137 for module instance. There, a help file URL (help=“/OvSipDocs/C/help/VPNavigator/cardView.htm”) is specified. Referring to FIG. 12C, a help button 1214E is provided on portal view window 1208E. A similar help button is also displayed in the other portal view windows 1208 for which either the registration file 308 or the portal view profile 716 designate a help file. The specified help file is linked to help button 12143E by portal view management system 208. Such a help file can provide any desired information to assist the network administrator with information regarding the reference data miner module 204 and resulting display. Such a help display can include references or links to other sources of information. The title for this window 1208E is also specified in the module instance attributes (title=“Service Cards”).

The lines of code 16-18 are parameters that are passed to the data miner module 204 identified in the corresponding registration file 308. For this data miner module 204, the parameters are bound by <ServiceCard . . . > and </ServiceCard> elements. This is the syntax expected by this particular module 204. Between these elements, the referenced module 204 is instructed not to retrieve detailed information (details=“no”). Referring to FIG. 12C, Service Cards portal view window 1208E is shown at the top of left column 1204. Data miner module 204 returned management information indicating that the Cluster Service Status is normal, that the E-Mail service status is “minor” and that the Geo/Orga Services status is “major”.

The three remaining portal module references 1006F-H and corresponding portal view windows 1208F-H, respectively are arranged similar to the module instances described above. Portal module reference 1006F causes a corresponding data miller 204 to display a summary of the health of three services specified by the network operator. These include “Normal Services”, “Critical Services” and “Abnormal Services.” The format and content of such displays is specified by the network administrator through the configuration of portal view profile 1000. An interactive service browser is specified in portal module reference 1006G, and the corresponding view window 1208G is displayed in FIG. 12C. A topology map of provided services is defined in portal module reference 1006G and the corresponding display is provided in view window 1208G.

As one of ordinary skill in the art would find apparent, additional data miners 204 can be added to library 210 that perform other functions that result in the generation of management information desired by a particular network administrator. Importantly, this extensibility is beneficial in that new domains can be added to computing environment 100, a data miner 204 that references the associated domain manager 216 can be included in the service information portal 126.

IV. Closing

While various embodiments of the present invention have been described above, it should be understood that they have been presented by way of example only, and not limitation. For example, there is a portal view profile 716 that corresponds with each network administrator. In alternative embodiments, the association between portal view profiles 716 and network administrators can take on any arrangement. For example, there may be a one-to-one or one-to-many correspondence. As another example, the portal data miner modules 204 disclosed above are referenced in portal view profiles 716. In alternative embodiments, such profiles 716 can include the functionality; that is, the code, included in the referenced troubleshooting data miner modules 204. However, such an embodiment would result in some redundancy and, therefore, is not preferred over the disclosed embodiment. Another example is the form in which data is stored. In the exemplary embodiment, LUTs and databases are utilized. It should be understood that any type of data repository can be utilized. Similarly, the transfer of information between components of the invention as well as between the invention and external entities can be accomplished through any well known technique. For example, individual signals over data and control lines, data buses over which encoded information, shared libraries, and the like can be used to transfer information. In addition, the computer programs noted above may exist in a variety of forms both active and inactive. For example, the computer programs can exist as application-level software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general. It should also be understood that the methods described above are exemplary only, and that the operations, processes and steps of the method may be performed in a different order than illustrated or may be performed concunently to the extent possible given data limitations. Thus, the breadth and the scope of the present invention are not limited by any of the above exemplary embodiments, but are defined only in accordance with the following claims and their equivalents.

What is claimed is:

1. A service information portal for displaying customer-based portal view display of networked computing environments, wherein said portal view display includes management information of a type, depth and breadth specified by an end-user in a format and arrangement also specified by the end-user.

2. The service information portal of claim 1, wherein said service information portal comprises:
a portal view profile manager that provides a portal view profile associated with the end user, wherein said portal view profile is configured and causing generation of a customized portal view display; and
a portal view display manager that executes said portal view profile to generate said customized portal view display.

3. The service information portal of claim 2, wherein said service information portal further comprises:
a portal view edit manager that enables the end user to interact with said referenced data miners to modify portions of said portal view profile that reference said data miners.

4. The service information portal of claim 3, wherein said service information portal further comprises:
a help display manager that displays help files in response to an end user's request.

5. The service information portal of claim 1,
wherein said portal view profile manager comprises a database of executable portal view profiles each designed for and/or by a particular end-user, wherein each said portal view profiles includes a reference to one or more selected data miners included in a library of a plurality of data miners, and
wherein said portal view display manager executes one of said portal view profiles and the data miners referenced therein, wherein each said data miner module extracts data from predetermined entities in the computing environment for generating data and derives said management information therefrom.

6. The service information portal of claim 1, wherein said portal view display is generated automatically with no end-user action beyond logging into the service information portal.

7. The service information portal of claim 1, wherein said portal view profile is associated with a group of end-users including said end-user.

8. The service information portal of claim 1, wherein said computing environment includes domain managers accessed by said data miners, wherein said domain managers comprise one or more of the group consisting of:
network managers that manage individual and collections of networks;
software application managers that manage software applications executing on a node or server of the computing environment;
database managers that manage databases executing on a node or server of the network system; and
server managers that assist a network administrator manage the operations of each server in a network.

9. The service information portal of claim 1, wherein said portal view display format, depth breadth and arrangement are determined by attributes included in said portal view profile.

10. The service information portal of claim 5, wherein said portal view profile manager further comprises:
a repository of mapping data that associates each end-user and one of said portal view profiles; and
a profile selector that, based on said end-user, retrieves from said repository one of said portal view profiles that is to be implemented for said selected end-user,
wherein, for each of said references to a data miner, said portal view profile selector verifies that said reference has a syntax appropriate for said referenced data miner.

11. The service information portal of claim 4, wherein said portal view profile is an extensible, executable software program that invokes a pre-determined combination of data miners that generate or cause the generation of management information to assist the user manage the computing environment..

12. The service information portal of claim 11, wherein each said portal view profile comprises sheet display specifications defining one or more sheets of management information, said sheets displayed alternatively, wherein said sheet display configuration includes specifications defining one or more columns within each said one or more sheets, wherein said column specifications including one or more data miner references, wherein each portal module reference includes portal module configuration parameters that provide attribute settings to the referenced portal view module when it is invoked.

13. The service information portal of claim 10, wherein said portal view profile selector further accesses a database of portal view specification files, each said portal view specification file defining a grammar that is to be used in a portal view profile in connection with a corresponding portal view module.

14. The service information portal of claim 13, wherein said portal view profile specification is a document type descriptor (.dtd) file and wherein said portal view profile is an XML file.

15. The service information portal of claim 1, wherein said portal view display includes a series of windows each allocated to the display of management information provided by a particular data miner.

16. The service information portal of claim 2, wherein said portal view display manager displays a detailed portal view display of a selected one of said series of windows in response to a request by the end user.

17. The service information portal of claim 2, wherein said portal view edit manager provides the end user with the ability to modify said portal view profile.

18. The service information portal of claim 3, wherein said portal view edit manager enables the end user to modify said data miners referenced in said portal view profile.

19. A service information portal for providing a network administrator with a customizable, extensible portal view display of management information reflective of a desired aspect of a computing environment.

20. The service information portal of claim 19, wherein said portal view display includes management information of a type, depth and breadth specified by the network administrator in a format and arrangement also specified by the network administrator through a graphical user interface.

21. The service information portal of claim 20, wherein said service information portal comprises:
a portal view profile manager that provides a portal view profile associated with the end user, wherein said portal view profile is configured and causing generation of a customized portal view display; and
a portal view display manager that executes said portal view profile to generate said customized portal view display.

22. The service information portal of claim 21, wherein said service information portal further comprises:
a portal view edit manager that enables the end user to interact with said referenced data miners to modify portions of said portal view profile that reference said data miners to cause said data miners.

23. The service information portal of claim 1, wherein a portal view profile manager comprises:
a database of executable portal view profiles each designed for and/or by a particular end-user, wherein each said portal view profiles includes a reference to one or more selected data miners included in a library of a plurality of data miners; and
wherein said portal view display manager executes one of said portal view profiles and the data miners referenced therein,
wherein each said data miner module extracts data from predetermined entities in the computing environment for generating data and derives said management information therefrom.

24. The service information portal of claim 23, wherein said portal view display format, depth breadth and arrangement are determined by attributes included in said portal view profile.

25. The service information portal of claim 23, wherein said portal view profile is an extensible, executable software program that invokes a pre-determined combination of data miners that generate or cause the generation of management information to assist the user manage the computing environment..

26. A method for displaying a portal view display of management information relevant to a particular end user and computing environment, comprising:
A) receiving an identifier of the end user;
B) generating management information specified by the end user, said management information directed only to a portion of the computing environment for which said end user is authorized to manage; and
C) displaying said management information on a display device in a format, arrangement specified by the end user.

27. The method of claim 26, wherein generating said management information comprises:
1) providing a database of data miner modules, each said data miner module generating or causing the generation of management information related to a particular network entity or function;
2) generating a database of portal view profiles each referencing a predetermined one or more data miner modules to display management information pertinent to a particular end user;
3) retrieving from said database of portal view profiles a portal view profile associated with said end user; and
4) invoking said retrieved portal view profile and said one or more data miner modules referenced therein.
